(19) United States
(12) Patent Application Publication
(10) Pub. No.: US 2007/0100815 A1
(43) Pub. Date: May 3, 2007

(54) Information management device, information management system, and computer usable medium

(75) Inventors: Kazushige Muroi, Nagoya-shi (JP); Satoru Yanagi, Nagoya-shi (JP); Kazuma Aoki, Kasugai-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA\

(21) Appl. No.: 11/529,268

(22) Filed: Sep. 29, 2006

(30) Foreign Application Priority Data
Sep. 30, 2005 (JP) P2005-288539

(51) Int. Cl. G06F 17/30

(52) U.S. Cl. 707/5

(57) ABSTRACT

When a first period in which a target document is utilized overlaps with a second period in which a utilization document utilized, the target document and the utilization document are correlated with each other. When the utilization document is updated in the second period, a correlation score is given to the correlation between both, and then a document address for identifying the utilization document is preferentially output as being correlated with the target document in accordance with the correlation score.

### CROSS REFERENCE TO RELATED APPLICATION

This application claims priority from Japanese Patent Application No. 2005-288539, filed Sep. 30, 2005, the contents of which are hereby incorporated by reference into the present application.

### TECHNICAL FIELD

Aspects of the present invention relate to an information management device and an information management system for managing a plurality of data as a management target and a program associated with the information management device.

### BACKGROUND

In recent years, personal computers (hereinafter, referred to as “PC”) have been widely spread and used for a personal purpose or on business. For example, a PC is connected to an external device serving as an information input source or an external device for performing an operation based on a command from the PC in a communication-practicable manner. Specifically, the PC is supplied with a large amount of data from the external devices and the information is used and managed by the PC, while the processes based on the managed information are performed to the external devices. In the environment in which it is difficult to install a plurality of external devices corresponding to the processes, a so-called multifunction machine having a plurality of means for executing a plurality of functions is connected to the PC.

The PC and the external devices transmit and receive a large amount of information therebetween in association with operations of the external devices, and the large amount of information is managed by the PC (for example, see JP-A-2004-32085).

In the PC for managing a large amount of data, there have been suggested techniques for correlating data with each other so as to enhance the efficiency of works using the data to be managed.

For example, there is known an information management system which can perform the correlating operation by allowing a message requesting for an instruction of correlating conditions to be displayed and allowing a user to give an instruction in response to the display so as to correlate one data to be written or one data previously written with another data and which can display the another data correlated with the one data at the time of utilizing the one data (for example, see JP-A-2000-315203).

### SUMMARY

Aspects the present invention provide an information management device which can manage data so that second data having a high degree of correlation with first data can be distinguished from another second data at the time of offering the second data correlated with the first data to a user, an information management system including the information management device, and a program for executing a predetermined operation to the information management device.

### BRIEF DESCRIPTION OF THE DRAWINGS

FIG. 1 is a diagram illustrating a configuration of an information management system according to an illustrative aspect of the present invention;

FIG. 2 is a diagram illustrating a status table according to an illustrative aspect of the invention;

FIG. 3 is a diagram illustrating definitions of items stored in the status table according to a first illustrative aspect of the invention;

FIG. 4 is a diagram illustrating a document table according to an illustrative aspect of the invention;

FIG. 5 is a diagram illustrating a file information table according to an illustrative aspect of the invention;

FIG. 6 is a diagram illustrating a device designating table according to an illustrative aspect of the invention;

FIG. 7 is a diagram illustrating a flow of a main process performed by a PC according to an illustrative aspect of the invention;

FIG. 8 is a diagram illustrating a flow of a before-activation intellectual assistance process according to an illustrative aspect of the invention;

FIG. 9 is a diagram illustrating a flow of an event document search process according to an illustrative aspect of the invention;

FIGS. 10A, 10B, and 10C are diagrams illustrating a display format resulting from the before-activation intellectual assistance process according to the invention;

FIG. 11 is a diagram illustrating a flow of a during-activation intellectual assistance process according to the first illustrative aspect of the invention;

FIG. 12 is a diagram illustrating a flow of a GID search condition setting process according to the first illustrative aspect of the invention;

FIG. 13 is a diagram illustrating a flow of a document search process according to an illustrative aspect of the invention;

FIG. 14 is a diagram illustrating a document-outputting search process according to an illustrative aspect of the invention;

FIG. 15 is a diagram illustrating a flow of the search result display process according to an illustrative aspect of the invention;

FIG. 16 is a diagram illustrating a display format (associated with the status table) of a search result in the during-activation intellectual assistance process according to an illustrative aspect of the invention;

FIG. 17 is a diagram illustrating a display format (associated with the document table) of a search result in the during-activation intellectual assistance process according to an illustrative aspect of the invention;

FIG. 18 is a diagram illustrating a display format (associated with the status table) of a search result in the during-activation intellectual assistance process according to an illustrative aspect of the invention;

FIG. 19 is a diagram illustrating a display format (associated with the document table) of a search result in the during-activation intellectual assistance process according to an illustrative aspect of the invention;

FIG. 20 is a diagram illustrating a flow of a status table registration process according to an illustrative aspect of the invention;

FIG. 21 is a diagram illustrating a flow of a manual intellectual assistance process according to an illustrative aspect of the invention;

FIG. 22 is a diagram illustrating a flow of the manual intellectual assistance process according to an illustrative aspect of the invention;

FIG. 23 is a diagram illustrating a flow of a document intellectual assistance process according to an illustrative aspect of the invention;

FIG. 24 is a diagram illustrating a display format (associated with the status table) of a search result in the manual intellectual assistance process according to an illustrative aspect of the invention;

FIG. 25 is a diagram illustrating a display format (associated with the document table) of a search result in the manual intellectual assistance process according to an illustrative aspect of the invention;

FIG. 26 is a diagram illustrating a flow of a document table updating process according to an illustrative aspect of the invention; and

FIG. 27 is a diagram illustrating a flow of the during-activation intellectual assistance process according to a second illustrative aspect of the invention.

### DETAILED DESCRIPTION

General Overview

According to an aspect of the invention, it is possible to obtain an information management device which can classify and manage correlated data in accordance with a degree of correlation.

According to another aspect of the invention, it is possible to provide an information management system which can classify and manage data correlated with output data in accordance with a degree of correlation.

According to still another aspect of the present invention, an information management device which correlates first data with second data when a first period of time in which the first data are utilized overlaps with a second period of time in which the second data are utilized, gives a score to the correlation when the second data are utilized in the second period of time in a utilization form, and preferentially outputs second identification information to identify the second data as being correlated with the first data in accordance with the score.

According to still another aspect of the invention, there is provided an information management device comprising: a data storage unit that stores a plurality of data; a utilization unit that utilizes the data; a period specifying unit that specifies a period in which the data is utilized by the utilization unit; a utilization information specifying unit that specifies identification information to identify the data which is used by the utilization unit in the period specified by the period specifying unit and event information indicating a utilization form of the utilization unit; a utilization information storage unit that correlates and stores the period, the identification information, and the event information which are specified by the period specifying unit and the utilization information specifying unit; a correlation giving unit that correlates first data and second data with each other when a first period for the first data and a second period for the second data stored in the utilization information storage unit overlaps with each other; a relevant information output unit that outputs second identification information to identify the second data correlated with the first data by the correlation giving unit; an event information specifying unit that specifies the event information stored in the utilization information storage unit for the second data correlated by the correlation giving unit; a score giving unit that gives a score to the correlation of the first data with the second data when the event information specified by the event information specifying unit indicates one utilization form and the utilization in the utilization form is performed in the second period; and a relevant information output control unit that controls to output the second identification information, to which the score is given by the score giving unit, on the basis of the given score.

Accordingly, it is possible to correlate the first data and the second data, which are stored in the data storage unit and are utilized at the same time (in the same period), with each other on the basis of the utilization form of the second data at that time, thereby offering another data to a user in accordance with the degree of correlation with one data.

The “information management device” is a concept including a structure in which one or more means constituting the information management device constitute one device and a plurality of devices can be connected to each other in a communication-practicable manner, in addition to a structure having physically one device.

The “period” includes factors of time points.

The “identification information” may be “a file name”, “a thumbnail”, and other information to identify data, or may be data itself.

The “score” may be a point expressed by a “numeral” or may be information for distinguishing one data from another data which is not utilized by the utilization unit or is simply output by the output unit without being searched out by the search unit.

According to still another aspect of the invention, there is provided an information management system comprising: the information management device; and an external device which is connected to the information management device in a communication-practicable manner and has at least one function performing unit including an output unit that outputs data in response to a command from the information management device, wherein the external device comprises a transmission unit that transmits process specifying information, which is used to specify a process on condition that the process is performed by the function performing unit, to the information management device, wherein the information management device comprises: a reception unit that receives the process specifying information transmitted from the external device; a process information storage unit that correlates and stores the process specifying information received by the reception unit with third identification information to identify the data as a target of the process; and a process detail determining unit to determine that the process specifying information stored in the process information storage unit is associated with the output unit, wherein the utilization unit can instruct the external device to output the data, and wherein the correlation giving unit correlates data associated with the third identification information correlated and stored with the process specifying information as a target of the determination and a period correlated with the data associated with the third identification with each other as the first data and the first period, when the process detail determining unit determines that the process specifying information is associated with the output unit.

Accordingly, it is possible to correlate the second data, which are stored in the data storage unit and are repeatedly utilized at the same time (in the same period) as a period in which data (consequently the first data) of which the output is instructed to the external device are utilized, with each other on the basis of the utilization form of the second data at that time.

According to still another aspect of the invention, there is provided a computer usable medium having computer readable instructions stored thereon, the instructions enabling a computer to perform predetermined operations including the steps of: storing a plurality of data; utilizing the data; period specifying for specifying a period in which the data are utilized; utilization information specifying for specifying identification information to identify the data which is used by the utilizing in the period specified by the period specifying and event information indicating a utilization form of the utilizing; utilization information storing for correlating and storing the period, the identification information, and the event information which are specified by the period specifying and the utilization information specifying; correlation giving for correlating first data and second data with each other when a first period for the first data and a second period for the second data stored in the utilization information storing overlaps with each other; a relevant information outputting for outputting second identification information to identify the second data correlated with the first data by the correlation giving; event information specifying for specifying the event information stored in the utilization information storing for the second data correlated by the correlation giving; score giving for giving a score to the correlation of the first data with the second data when the event information specified by the event information specifying indicates one utilization form and the utilization in the utilization form is performed in the second period; and relevant information output controlling for controlling to output the second identification information, to which the score is given by the score giving, on the basis of the given score.

Accordingly, it is possible to correlate the first data and the second data, which are repeatedly utilized at the same time (in the same period), with each other on the basis of the utilization form of the second data at that time.

### FIRST EXAMPLE

Hereinafter, a specific information management system according to an illustrative aspect of the invention will be described with reference to the drawings. The invention is not limited to the configuration described below, but may employ a variety of configurations within the same technical spirit.

(Configuration of Information Management System)

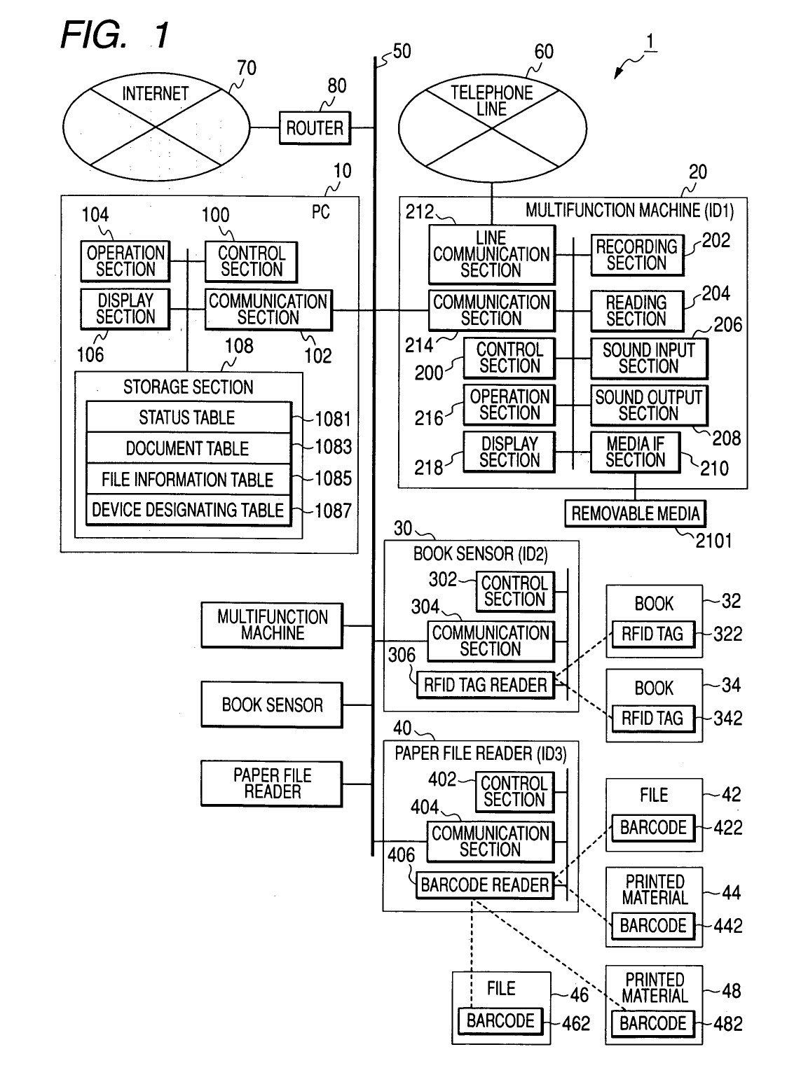

FIG. 1 is a diagram illustrating an information management system. As can be seen from the figure, the information management system 1 comprises a PC 10 as an information processing device comprising an information management function, a multifunction machine 20 as an external device for performing a variety of functions, a book sensor 30 as an external device for sensing books 32 and 34 as a management target of the PC 10, and a paper file reading section 40 as an external device for sensing paper files 42 and 46, which are stationery for filing paper as a management target of the PC 10, and printed materials 44 and 48. The devices are all connected to each other through a network line 50.

The PC 10 comprises a CPU, a ROM, and a RAM (not shown), and further comprises a control section 100 for controlling operations of the PC 10 (the entire PC 10) on the basis of programs stored in the ROM, a communication section 102, which is connected to the network line 50 so as to control the network line 50, an operation section 104 for receiving instructions from a user of the PC 10, a display section 106 for displaying a variety of information, and a storage section 108 comprising a hard disk or the like.

The storage section 108 comprises a status table 1081, a document table 1083, a file information table 1085, and a device designating table 1087. Details of the tables will be described later.

The multifunction machine 20 comprises a CPU, a ROM, and a RAM (not shown), and further comprises a control section 200 for controlling operations of the multifunction machine 20 (the entire multifunction machine 20), a recording section 202 as an image forming unit, a reading section 204 as an image reading unit, a sound input section 206 as a microphone, a sound output section 208 as a speaker, and a media IF section 210 fitted with a removable media 2101. The multifunction machine further comprises a line communication section, which is connected to a telephone line 60 so as to control the telephone line 60, a communication section 214, which is connected to the network line 50 so as to control the network line 50, an operation section 216 for receiving instructions from a user of the multifunction machine 20, and a display section 218 for displaying a variety of information.

A device ID (multifunction machine ID 1) indicating that it is a device constituting the information management system 1 is given to the multifunction machine 20.

The book sensor 30 comprises a CPU, a ROM, and a RAM (not shown), and further comprises a control section 302 for controlling operations of the book sensor 30 (the entire book sensor 30), a communication section 304, which is connected to the network line 50 so as to control the network line 50, and a radio-frequency (RF) ID tag reading section 306 for reading information of RFID tags 322 and 324 given to books 32 and 34.

The book sensor 30 serves as a device for storing information indicating what book is in a user's hands at what times (is being read or is ready to be read). That is, when the RFID tag read 306 is activated on the basis of the program stored in the ROM of the control section 302 and a response is read from the RFID tag 332 or 342 of the books 32 and 34, the identification information on the RFID tag 332 or 342 and the present time (start time) are temporarily stored in the RAM of the control section 302. Then, when the response read from the RFID tags 332 or 342 ends, the identification information on the RFID tag 332 or 342 and the start time temporarily stored in the RAM of the control section 302 and the present time (end time) are transmitted to the PC 10 through the communication section 304. The PC 10 stores the information in the statue table 1081.

A device ID (book sensor ID 2) indicating that it is a device constituting the information management system 1 is given to the book sensor 30.

The paper file reading section 40 comprises a CPU, a ROM, and a RAM (not shown), and further comprises a control section 402 for controlling operations of the paper file reading section 40 (the entire paper file reading section 40), a communication section 404 connected to the network line 50 so as to control the network line 50, and a barcode reading section 406 for reading barcodes 422, 442, 462, and 482 given to the paper files 42 and 46 or the printed materials 44 and 48. The paper file reading section 40 serves as an input section for forming information, which is used to correspond the paper files 42 and 46 with the printed materials 44 and 48 filed in the paper files, in a file information table 1085. That is, the paper file reading section inputs the barcodes of the paper files through the barcode reading section 406 on the basis of a program stored in a ROM of the control section 402, and then inputs the barcodes of the printed materials, in which the barcodes are temporarily stored in a RAM of the control section 402. The input data temporarily stored are transmitted to the PC 10 through the communication section 404. The PC 10 receives the information and adds the received information to the status table 1081 and the file information table 1085.

A device ID (paper file reading section ID 3) indicating that it is a device constituting the information management system 1 is given to the paper file reading section 40.

Now, information stored in the status table 1081, the document table 1083, the file information table 1085, and the device designating table 1087, which are all stored in the storage section 108 of the PC 10, will be described.

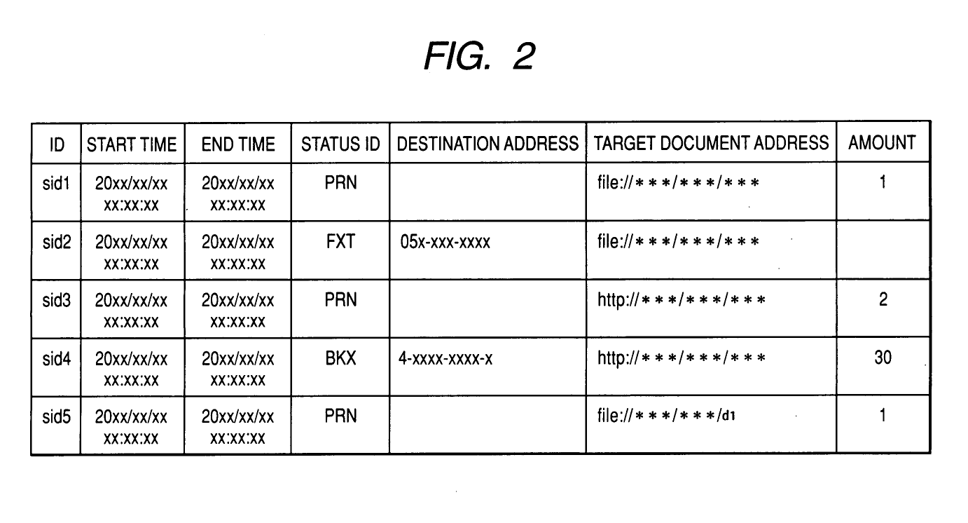

As shown in FIG. 2, the status table 1081 stores a processing operation (status ID) executed by an execution unit of the multifunction machine 20, start and end times of the processing operation (wherein it can be properly determined what time is set as the start time or the end time), information (hereinafter, referred to as “target document address”) indicating a location of a document which is a target of the processing operation (hereinafter, referred to as “target document”), a destination address for specifying a specific counter party when the processing operation is performed to the specific counter party, and an amount of the target document which is a target of the processing operation, as one record every time when the processing operation is performed. A unique ID for identifying the processing operation is given to each processing operation.

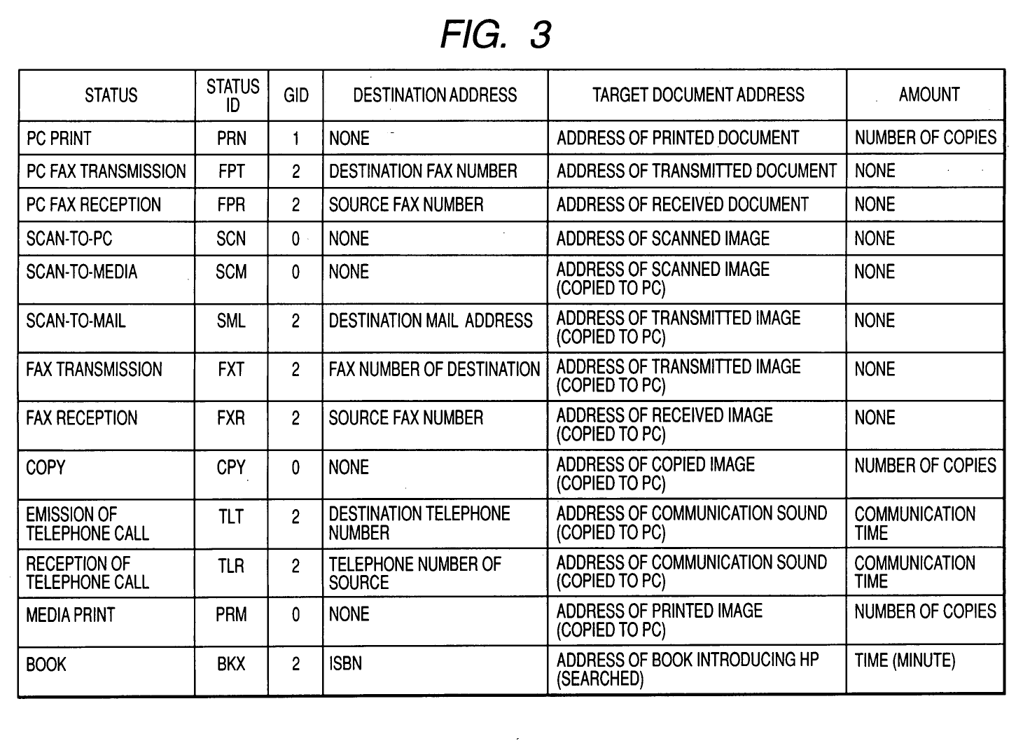

The status ID stored in the status table 1081 is defined as shown in FIG. 3. For example, when the PC 10 performs a print job using the recording section 202 of the multifunction machine 20 (this case is defined as a status “PC print” in FIG. 3), the status ID is set to “PRN”, the destination address is set to “None”, the target document address is set to “Address of printed document”, and the amount is set to “Number of copies.”

Since the PC print operation is performed between the PC 10 and the multifunction machine 20, the destination address is set to “None.” Since the document as a target of the processing operation is stored in the storage section 108 of the PC 10, an address of the storage section 108 storing the target document or an address of a homepage (hereinafter, referred to as “HP”) when the target document is a specific HP is stored as the target document address. The amount is set to the “Number of sheets.” For example, when a sheet of target document is printed, the amount is “one copy.”

When a facsimile (hereinafter, referred to as “fax”) transmission is performed using the reading section 204 and the line communication section 212 of the multifunction machine 20 (this case is defined as a status “fax transmission” in FIG. 3), the status ID is set to “FAX”, the destination address is set to “Destination FAX number”, the target document address is set to “Address of transmitted image (copied to PC)”, and the amount is set to “None.”

Since the fax transmission is performed between the multifunction machine 20 and a different facsimile machine, the destination address is set to “Destination FAX number.” In the information management system 1, when the fax transmission is performed, the transmitted image as a target of the fax transmission is stored in the storage section 108 of the PC 10. Accordingly, an address in the storage section 108 in which the transmitted image is stored (an address of the transmitted image (copied to the PC)) is defined as the “Target document address” (in the process (status) defined as “(copied to the PC)” in the target document address in FIG. 3, an address in the storage section 108 in which an image or sound is stored as a processing target as described above is defined as the target document address.).

When the books 32 and 34 managed by the PC 10 are used (this case is defined as a status “Book” in FIG. 3), the status ID is set to “BKX”, the destination address is set to “Japanese book code (hereinafter, referred to “ISBN”)”, the target document address is “Book introducing HP address (searched)”, and the amount is set to “time (minute).”

ISBN used as the destination address serves to identify the books 32 and 34 and is stored in RFID tags 322 and 342. The address of the HP introducing the books 32 and 34 is provided for a general purpose and is defined as the address stored as the target document address. The amount is set to the time (minute) for using the books 32 and 34.

In addition to those described above, “PC fax transmission (the pc transmits image data and destination to the multifunction machine 20 through the communication section 102 and the multifunction machine 20 fax transmits received image data through the line communication section 212)”, “PC fax reception (the line communication section 212 of the multifunction machine 20 transmits the received image data to the PC 10 through the communication section 214 and the PC 10 stores the received image data”, “Scan-to-PC (the multifunction machine 20 transmits the image data scanned by the reading section 204 to the PC 10 through the communication section 214 and the PC stores the received image data)”, “Scan-to-media (the image data scanned by the reading section 204 are stored in the removable media 2101 through a media interface (hereinafter, referred to as “media IF”) section 210)”, “Scan-to-mail (the image data scanned by the reading section 204 are transmitted through the communication section 214)”, “Fax reception (the image data received by the line communication section 212 are printed by the recording section 202)”, “Copy (the image data read by the reading section 204 are printed by the recording section 202)”, “Telephone transmission”, “Telephone reception”, and “Media print (the image data or the document data stored in the removable media 2101 are printed by the recording section 202) are defined respectively.

The paper file ID used as the destination address serves to identify the paper files 42 and 46 or the printed materials 44 and 48 and are given as barcodes to the paper files 42 and 46 or the printed materials 44 and 48. The address stored as the target document address is set to an address in the storage section 108 storing the document data constituting the documents or printed materials 44 and 48 filed in the paper files 42 and 46.

“GID (Group ID)” defined in FIG. 3 is an individual ID given to respective groups into which the respective processing operations (statuses) are divided. Specifically, GID “2” is given to the processing operation of which the destination address is stored, but “0” and “1” are given to the processing operations of which the destination address is set to “None.” GID “1” is given to a processing operation (only “PC print” in the illustrative aspect) using target document data previously stored in the storage section 108, and GID “0” is given to a processing operation of which target document data are stored by performing the processing operation.

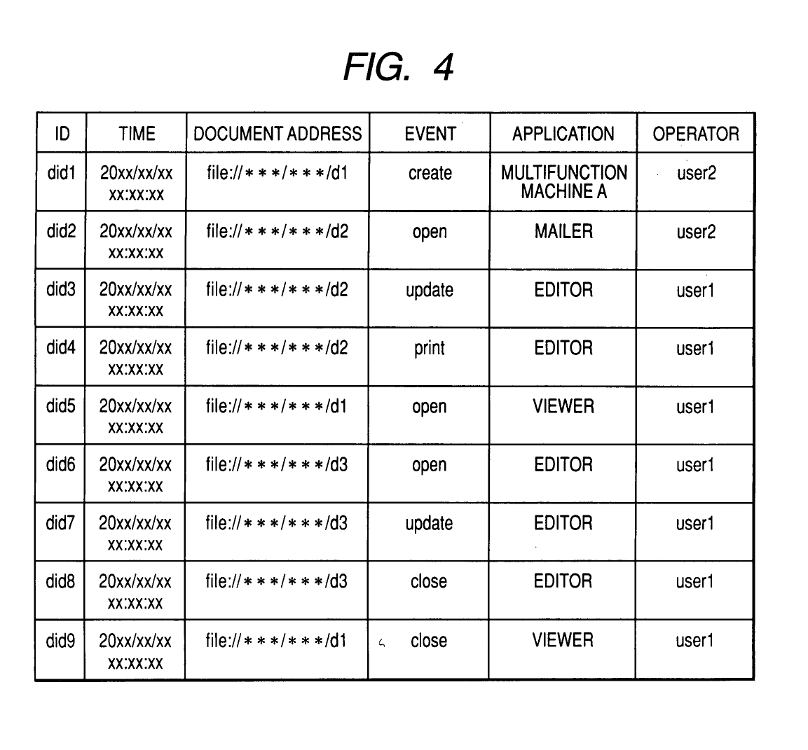

The document table 1083 stores a work or instruction performed to a document. Here, as shown in FIG. 4, an ID is given to a time when the work or the like is performed (wherein it can be properly determined what time the work or the like is performed), information indicating a location of the document, a work or the like (event) performed to the document, a device performing the work or the like (operating application), and a user carrying out the work.

Data treated in the document table 1083 comprise the document data, image data, and sound data.

Here, as a work (event) performed to a document, “create”, “open”, “update”, “print”, “send”, and “close” are defined. More specifically describing the events, when a new document is prepared, for example, when a document is prepared by a manipulation of the operation section 104 of the PC 10, when a document is scanned or copied by the use of the reading section 204 of the multifunction machine 20, the document is received in fax or in PC fax by the use of the line communication section 212, or when a communication sound is stored through telephone transmission or telephone reception using the line communication section 212, “create” is stored as an event in the document table 1083.

When the document data, the image data, or the sound data stored in the storage section 108 of the PC are opened by the use of the operation section 104 and when an HP is opened by the use of the operation section 104, “open” is stored as an event in the document table 1083. When the document data or the like are closed, “close” is stored.

When the document data, the image data, or the sound data previously stored in the storage section 108 are updated by an editor stored in the PC 10, “update” is stored as an event in the document table 1083.

When the document data or the image data previously stored in the storage section 108 are printed by the editor, “print” is stored as an event in the document table 1083.

When the document data, the image data, or the sound data previously stored in the storage section 108 are transmitted by a mail transmitting and receiving application stored in the PC 10, or when the document data or the image data previously stored in the storage section 108 are transmitted through the PC fax transmission or the fax transmission of the multifunction machine 20, “send” is stored as an event in the document table 1083.

In the document table 1083, one of the above-mentioned items is stored as a record every time when a work is performed to a document, like in the status table 1081.

Here, the status table 1081 and the document table 1083 need not be two tables different from each other, but may be one table if only the items constituting the records of the tables can be specified.

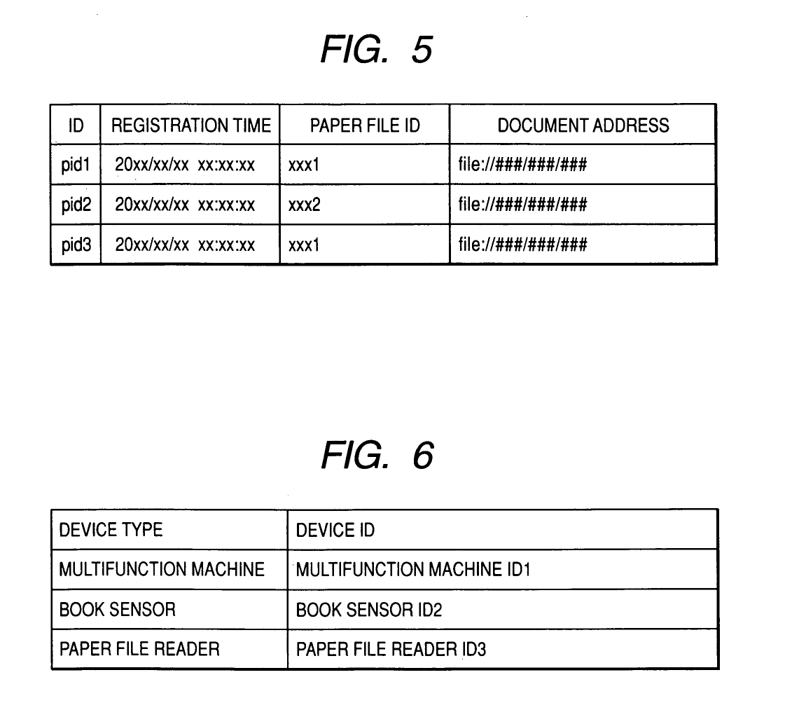

As shown in FIG. 5, a unique ID for identifying a record, a time when the record is written, a paper file ID for identifying the paper files 42 and 46, and a document address for specifying the printed materials 44 and 48 filed in the paper files 42 and 46 are stored as a record in the file information table 1085.

The paper file ID serves to identify the paper files 42 and 46 and is written in barcodes 442 and 462. The document address stored as the target document address serves to correlate the paper files 42 and 46 with the printed materials 44 and 48 filed therein and denotes an address of an electronic document resulting in the printed materials 44 and 48. That is, when the electronic document resulting in the printed materials 44 and 48 is stored in the storage section 108 of the PC 10, the address in the storage section 108 storing the electronic document is stored as the document address, or when the electronic document is an HP, the address of the HP is stored as the document address. The information is written to the barcodes 442 and 448 recorded in the printed materials 44 and 46.

When a plurality of multifunction machines 20, the book sensor 30, and the paper file reading section are connected to the network line 50, the device designating table 1087 is a table, which specifies and stores a target of the information management system 1 among the multifunction machines 20 and the like. The device designating table comprises the structure shown in FIG. 6.

(Process 1 of Information Management System)

Next, process (1) of the information management system illustrated as above will be described with reference to the figures.

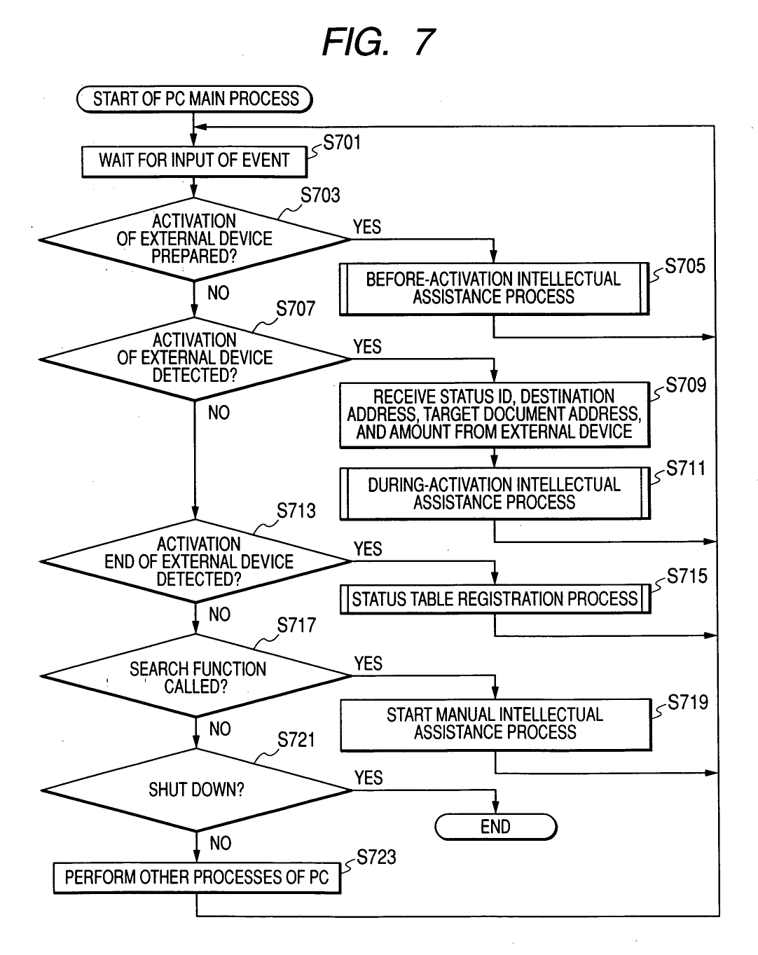

FIG. 7 is a diagram illustrating a flow of a main process performed by the PC 10. The process shown in the flow is performed by the control section 100 of the PC 10, and more specifically, the CPU of the control section 100 performs the process by the use of a program stored in the ROM or the like.

First, the control section 100 waits until an instruction for performing any one process is input through the operation section 104 of the PC 10 or the communication section 102 from a designated external device shown in FIG. 6, such as the multifunction machine 20, the book sensor 30, and the paper file reading section 40 (step 701).

Thereafter, when it is detected in step 701 that an instruction is given, the process is specified. That is, when an instruction is input to the control section 100 first determines whether the instruction is an instruction for activating a printer driver controlling the recording section 202 of the multifunction machine 20 or an instruction for preparing for activation of the external device such as activation of a multifunction machine utility for using the reading section 204 of the multifunction machine 20 (step 703).

When it is determined in step 703 that the input instruction is to prepare for the activation of the external device (step 703: YES), the control section 100 of the PC 10 performs a before-activation intellectual assistance process to be described later (step 705) and waits until an instruction for performing a process is input (step 701).

The before-activation intellectual assistance process means a process of alarming a user having given the instruction so as to prevent the redundant printing when an instruction for printing the specified document data is given to the recording section 202 of the multifunction machine 20 from the PC 10 but the process of printing the document is previously performed within a predetermined time. The before-activation intellectual assistance process comprises a process of alarming a user having given a fax transmission instruction so as to prevent the redundant fax transmission when the fax transmission instruction for transmitting specific document data to a specific counter party is given to the line communication section 212 of the multifunction machine 20 from the PC 10 but the document data are previously transmitted to the counter party.

On the other hand, when the input instruction is not to prepare for the activation of the external device (step 703: NO), it is determined whether the instruction detected in step 701 is an instruction from one of the multifunction machine 20, the book sensor 30, and the paper file reading section 40 designated in FIG. 6 and an instruction for detecting the activation of the external device (step 707).

When it is determined in step 707 that the instruction is to detect the activation of the external device (step 707: YES), the control section 100 receives the information defined in FIG. 3, that is, the status ID, the destination address, the target document address, and the amount, from the external device (step 709). The status ID and the like are stored in the RAM of the control section 100. When the activation of the external device results from the instruction from the PC 10, the PC 10 may store a document address as a target (target document address) of the instruction (in this case, the external device need not transmit the target document address).

Then, the control section performs a during-activation intellectual assistance process (step 711) and then waits until an instruction for performing another process is input when the process is finished (step 701).

The during-activation intellectual assistance process means a process for providing the information used until that time as information associated with a present work when a process corresponding to the same instruction as the instruction from the external device was performed in the past.

When the input instruction is not to prepare for the activation of the external device (step 707: NO), it is determined whether the instruction detected in step 701 is to detect the end of the detected activation of the external device (step 713).

When it is determined in step 707 that the instruction is to detect the end of the activation of the external device (step 713: YES), the control section 100 performs a status-table registration process to be described later (step 715) and then waits until an instruction for performing another process is input when the status-table registration process is finished (step 701).

When the input instruction is not to end the activation of the external device (step 713: NO), it is determined whether the instruction detected in step 701 is to call a search function (step 717).

When it is determined in step 717 that the input instruction is to call a search function (step 717: YES), the control section performs a manual intellectual assistance process to be described later (step 719) and then waits until an instruction for performing another process is input when the manual intellectual assistance process is finished (step S701).

The manual intellectual assistance process is to provide a user with information associated with a user' present work in response to a condition designated by the user.

When the input instruction is not the manual intellectual assistance process (step 717: NO), it is determined whether the instruction detected in step 701 is to shut down the PC 10 (step 721). When the instruction is to shut down the PC 10 (step 721: YES), the PC 10 is shut off. When the instruction is not to shut down the PC (step 721: NO), a process corresponding to the instruction is performed (step 723). After performing the process, the control section waits until an instruction for performing another process is input (step 701).

(Before-Activation Intellectual Assistance Process)

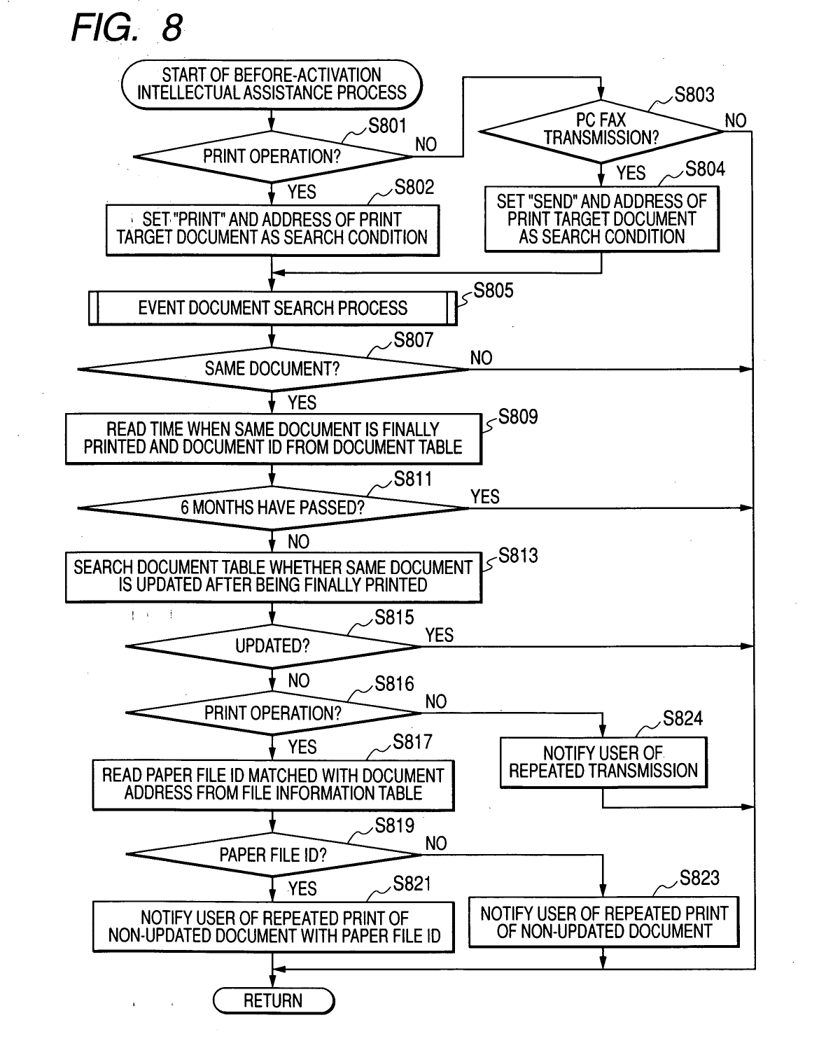

FIG. 8 is a diagram illustrating a flow of a before-activation intellectual assistance process.

When the before-activation intellectual assistance process is performed in step 705, it is first determined whether the input instruction for preparing for the activation of the external device is a printing instruction to the recording section 202 (step 801). When the input instruction is the printing instruction (step 801: YES), step 802 is performed. On the other hand, when the input instruction is not the printing instruction (step 801: NO), it is determined whether the input instruction for preparing for the activation of the external device is a PC fax transmission instruction to the line transmission section 212 (step 803). When the input illustration is the fax transmission instruction (step 803: YES), the process proceeds to step 804. When the input instruction is not the PC fax transmission instruction (step 803: NO), the control section ends the before-activation intellectual assistance process and waits again in step 701 until an instruction for performing another process is input.

In step 802, in order to confirm whether the same document data as the document data to be printed exist in the previously printed documents, that is, in the documents of which the event is stored as “print” in the document table shown in FIG. 4, the event “print” and the address of the document data to be printed are set as search conditions and an event document search process is performed on the basis of the two search conditions (step 805).

In step 804, in order to confirm whether the same document data as the document data to be transmitted in a PC fax manner and a record of transmission to the same designation exist in the previously transmitted documents, that is, in the documents of which the event is stored as “send” in the document table shown in FIG. 3, the event “send”, the destination address (fax number) of the PC fax transmission, and the address of the document data to be transmitted are set as search conditions and the event document search process is performed on the basis of the two search conditions (step 805).

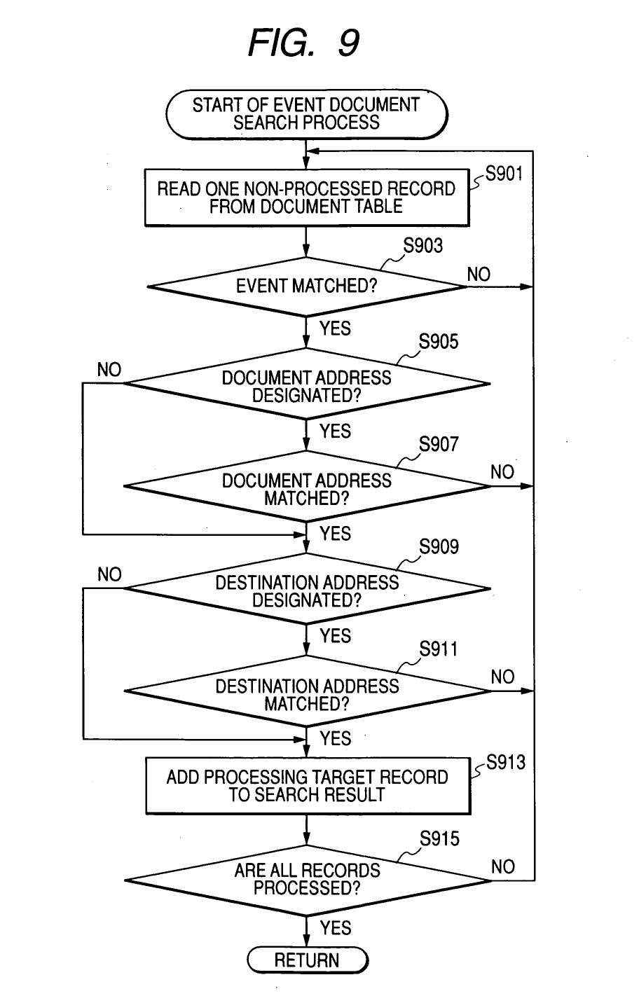

FIG. 9 is a diagram illustrating a flow of the event document search process. When the process starts, the control section 100 first reads one record, to which the process is not performed yet, from a document database 1083 (step 901). Then, the control section determines whether an event of the record to be processed is matched with the event “print” (“send”) set as the search condition in step 802 (or step 804) (step 903). Here, when the event of the record to be processed is not “print” (“send”) (step 903: NO), the record is excluded from the processing target and the process of step 901 is performed again.

On the other hand, when the event of the record to be processed is “print” (“send”) (step 903: YES), the control section determines whether the document address is set as the search condition of step 802 (or step 804) (step 905).

When it is determined in step 905 that the document address is set as the search condition of step 802 (or step 804) (step 905: YES), it is determined whether the document address of the record to be processed is matched with the document address designated as the search condition (step 907). When it is determined that the document addresses are matched with each other (step 907: YES), the process of step 909 is performed. When it is determined that the document addresses are not matched with each other (step 907: NO), the process of step 901 is performed again.

When it is determined in step 905 that the document address is not set as the search condition (step 905: NO), the process of step 907 is not performed, but the process of step 909 is performed.

When it is determined in step 909 that the destination address is set as the search condition of step 802 (or step 804) (that is, step 909: YES, when step 804 is performed), it is determined whether the destination address of the record to be processed is matched with the destination address designated as the search condition (step 911). When it is determined that the destination addresses are matched with each other (step 911: YES), the process of step 913 is performed. When it is determined that the destination addresses are not matched with each other (step 911: NO), the process of step 901 is performed.

When it is determined in step 909 that the destination address is not set as the search condition (that is, step 909: NO, when step 802 is performed), the process of step 911 is not performed, but the process of step 913 is performed.

When it is not determined in step 911 whether the destination addresses are matched with each other (step 905: NO or step 907: YES and step 909: NO), or when it is determined in step 911 that the destination addresses are matched with each other (step 905: NO or step 907: YES, step 909: YES, and step 911: YES), it is considered that the document data set as the search condition are previously printed or the document data set as the search condition are previously transmitted to the same designation, and thus the record to be processed is added to the search result (step 913).

Thereafter, it is determined in step 915 whether the event document search process has been performed to all the records of the document table. When the process has not been performed to all the records (step 915: NO), the process of step 901 is performed again. When the process has been performed to all the records (step 915: YES), the event document search process is finished and the process of step 807 is performed.

In step 807, it is determined whether the same document exists through the event document search process of step 805. Here, when it is determined that the same document does not exist (step 807: NO), the document data to be processed are not printed or transmitted to the same designation. Accordingly, the control section does not perform the subsequent processes (that is, performs the print or transmission process), but waits in step 701 until the next input is performed.

On the contrary, when the same document exists (step 807: YES), the ID and time associated with the latest record (finally printed or transmitted) are read from the records, which determined to be identical (step 809) and it is then determined whether the time passes 6 months from the present time (step 811).

When it is determined that the time passes 6 months (step 811: YES), the document data to be processed are redundantly printed or transmitted to the same designation. However, since a considerable time has passed from the final print or transmission, the control section does not perform the subsequent processes (that is, performs the print or transmission process), but waits again in step 701 until the next input is performed.

On the contrary, when it is determined that the time does not pass 6 months (step 811: NO), it is determined from the document table (see FIG. 4) whether the same document is updated (event “update”) after finally printed (event “print”) or transmitted (event “send”) (step 813).

When it is determined in step 815 that the same document is updated (step 815: YES), the control section performs the print or transmission process and then waits in step 701 until the next input is performed. On the other hand, when it is determined that the same document is not updated (step 815: NO), the type of manipulation is determined. When the manipulation indicates a print process (step 816: YES), the paper file ID corresponding to the document address is read from the file information table 1085 (step 817) so as to determine whether the previously printed document is managed in the file information table 1085 (see FIG. 5) along with the paper file ID thereof.

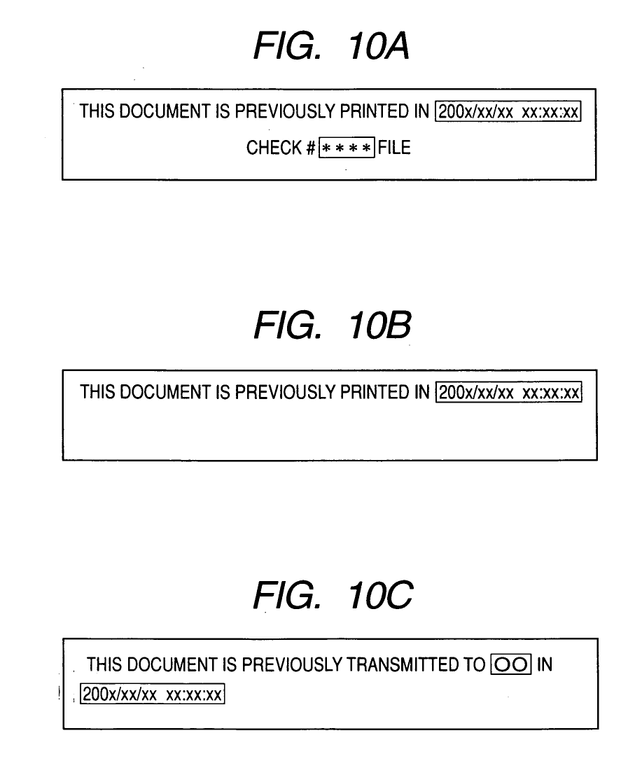

When it is determined in step 817 that the corresponding paper file ID exists in the file information table 1085, it is notified to the user in the manner shown in FIG. 10A that this print job is to redundantly print the non-updated document with the paper file ID (step 821).

On the other hand, when the corresponding paper file ID does not exist in the file information table 1085, it is notified to the user in the manner shown in FIG. 10B that the non-updated document is redundantly printed (step 823).

When the manipulation indicates a PC fax transmission (step 816: NO), it is notified to the user in the manner shown in FIG. 10C that the same document is transmitted to the same designation (step 824).

(During-Activation Intellectual Assistance Process)

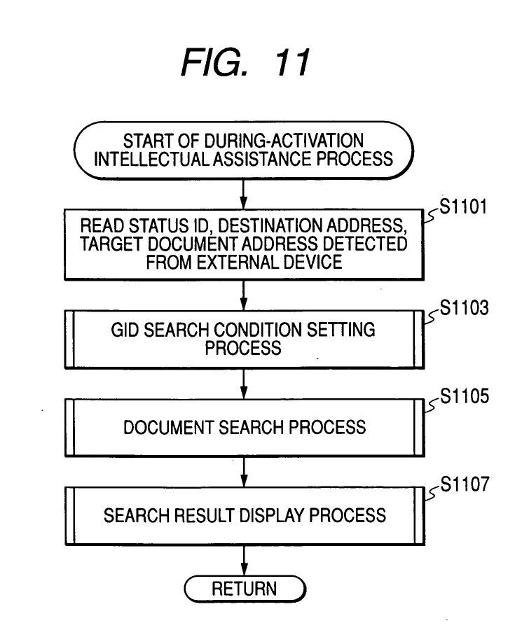

FIG. 11 is a diagram illustrating a flow of a during-activation intellectual assistance process.

In step 711, when the during-activation intellectual assistance process is performed, the control section 100 of the PC 10 first reads the status ID, the destination address, and the target document address input (detected) from the external device in step 709 (step 1101) and performs a GID search condition setting process (step 1103).

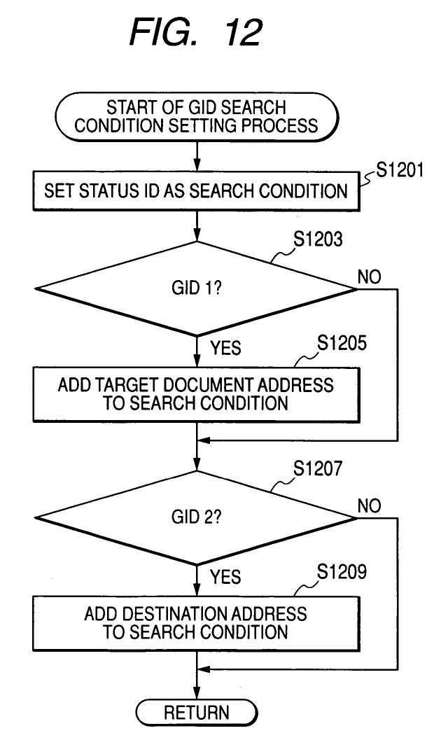

FIG. 12 is a diagram illustrating a flow of a GID search condition setting process. First, the status ID (see FIGS. 2 and 3) is set as the search condition (step 1201). Next, in order to specify a search condition for performing the search in a so-called “AND condition” with the status ID set in step 1201 when the document search process of step 1105 is performed, the format of a GID is determined to extract a search condition specific to the respective processing operations. That is, it is first determined whether the GID of the status ID set in step 1201 is “1” (see FIG. 3) (step 1203).

When it is determined in step 1203 that the GID is “1” (step 1203: YES), the target document address is added as the search condition (step 1205) and the process of step 1207 is performed. When it is determined in step 1203 that the GID is not “1”, the process of step 1205 is not performed, but the process of step 1207 is performed.

In step 1207, it is determined whether the GID of the status ID set in step 1201 is “2” (see FIG. 3) (step 1207).

When it is determined in step 1207 that the GID is “2” (step 1207: YES), the destination address is added as the search condition (step 1209). The GID search condition setting process is finished and then the document search process (step 1105) is performed using the search conditions specified through the GID search condition setting process.

On the other hand, when it is determined in step 1207 that the GID is not “2”, the GID search condition setting process is finished. Then, the document search process (step 1105) is performed using the search conditions specified through the GID search condition setting process.

When “NO” is determined together in steps 1203 and 1207, it is the case in which the GID corresponding to the status ID is “0.”

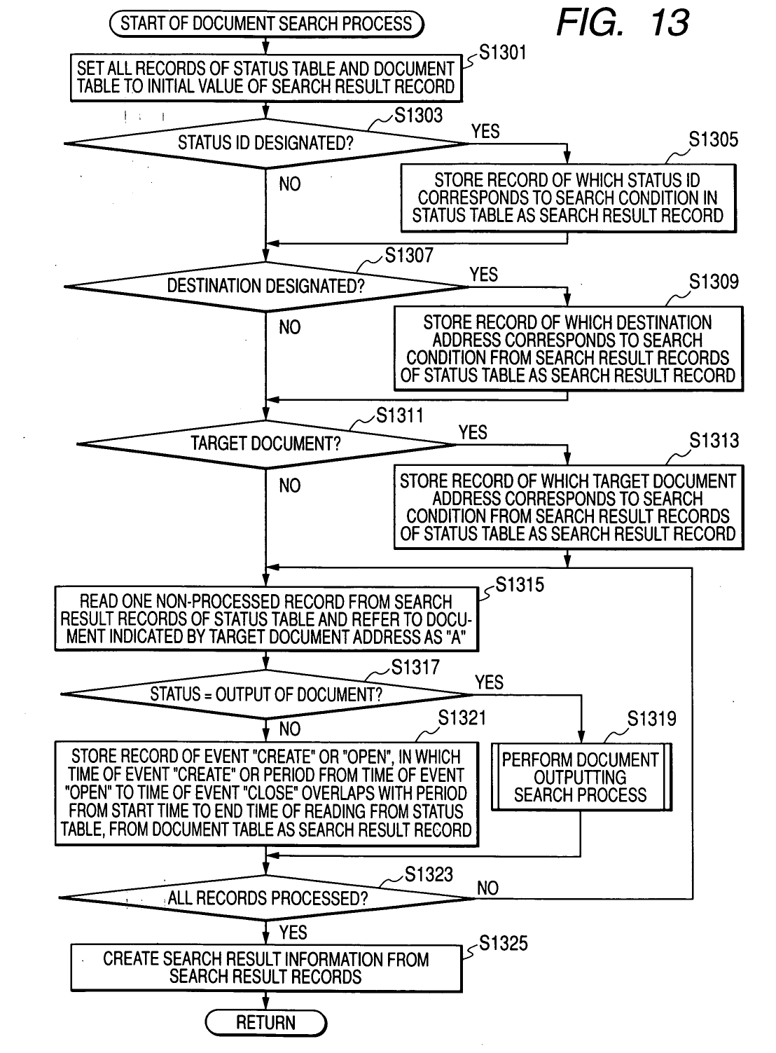

FIG. 13 is a diagram illustrating a flow of the document search process (step 1105). First, all the records of the status table 1081 and the document table 1083 are set to the initial value of a search result record (step 1301).

Next, in order to specify a target document associated with a specific record from the status table 1081, a search process is performed with the search conditions set in the GID search condition setting process (step 1103) previously performed.

That is, first, it is determined in step 1303 whether the status ID is designated as the search condition. In the during-activation intellectual assistance process (step 711), the status ID is generally set as the search condition in step 1201. Accordingly, the determination of step 1303 is “YES”, a record corresponding to the status ID set as the search condition from the status table 1081 is stored as a new search result record (step 1305), and then the process of step 1307 is performed.

In step 1307, it is determined whether the destination address is set as the search condition, that is, whether the determination of step 1207 is “YES” and the destination address is added as the search condition in step 1209. When it is determined that the destination address is set (step 1307: YES), a record corresponding to the destination address designated as the search condition from the search result records stored in step 1305 is stored as anew search result record (step 1309), and then the process of step 1311 is performed. When it is determined in step 1307 that the destination address is not set as the search condition (step 1307: NO), the process of step 1309 is not performed, but the process of step 1311 is performed.

It is determined in step 1311 whether the target document address is set as the search condition, that is, whether the determination of step 1203 is “YES” and the target document address is set as the search condition in step 1205. When it is determined that the target document address is set (step 1311: YES), a record corresponding to the target document address designated as the search condition from the search result records stored in step 1305 is stored as a new search result record (step 1313), and then the process of step 1315 is performed. When it is determined in step 1311 that the target document address is not set as the search condition (step 1311: NO), the process of step 1313 is not performed, but the process of step 1315 is performed.

In steps 1309 and 1313, a new search result record corresponding to the respective search conditions is stored on the basis of the search result record specified in step 1305. This is because only one GID corresponding to the respective status ID is set (see FIG. 3).

In step 1315, in order to perform the processes subsequent to the process of step 1317, one non-processed search result record (substantially one record in the status table 1081) is read from the search result records specified in steps 1303 to 1313 and the process of step 1317 is performed. A document indicated by the target document address included in the read non-processed search result is referred to as document “A.”

It is determined whether the status ID of the read record indicates a document output process (for example, “PRN” or FPT”) (step 1317). When it is determined that the record indicates the document output process (step 1317: YES), a document-outputting search process is performed in step 1319.

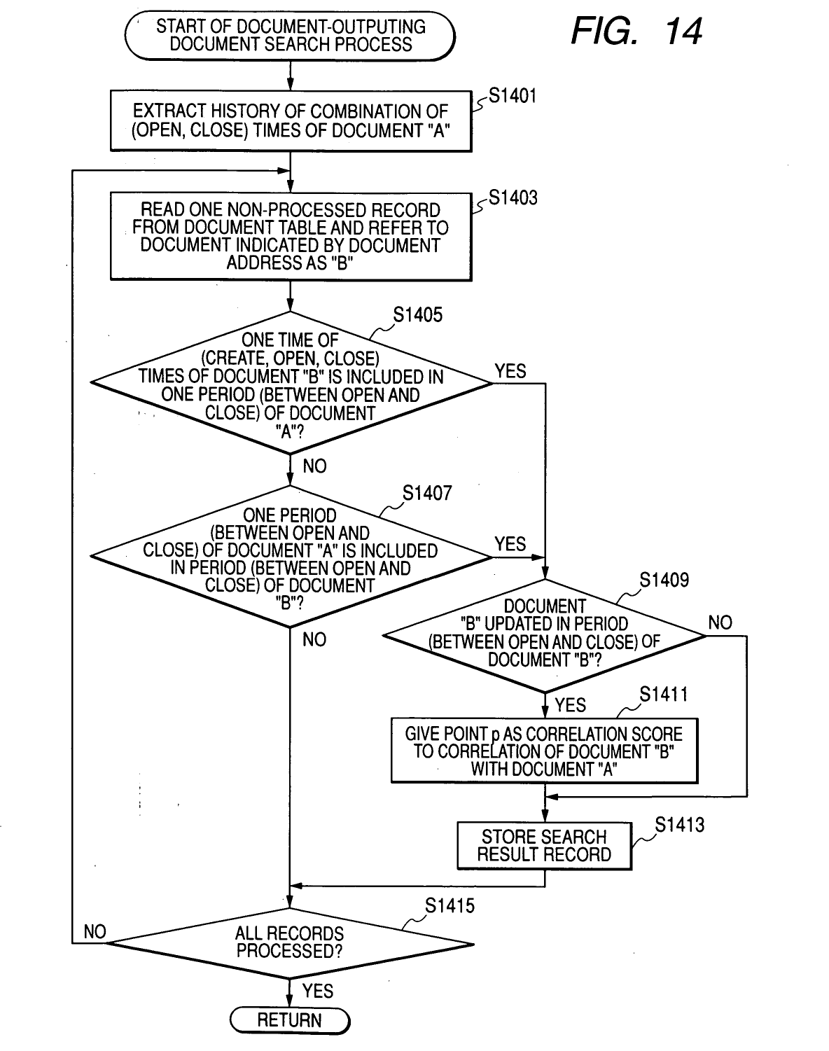

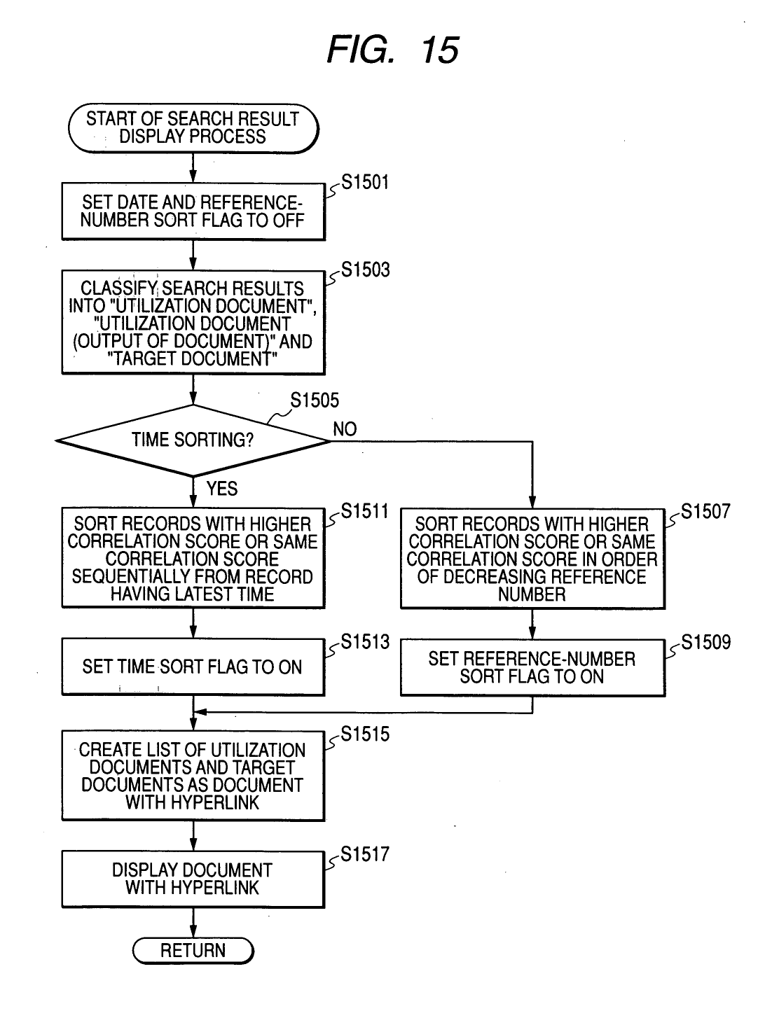

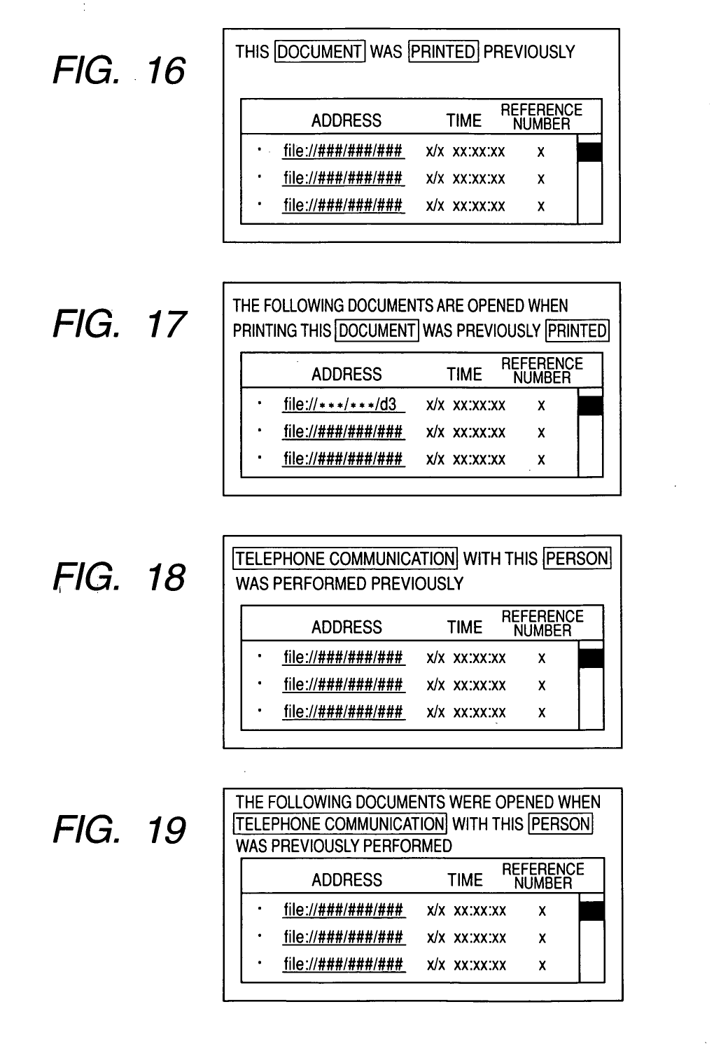

FIG. 14 is a diagram illustrating a flow of the document-outputting search process.

In the document-outputting search process, first, a period in which the document “A” indicated by the non-processed record read in step 1315 was previously utilized by the information processing device 10 is extracted. Specifically, records having the target document address indicating the document “A” and recording “open” as the event are searched in the document table 1083. Further, records having the target document address indicating the document “A” and recording “close” as the event are searched. A combination of times of the records in which “open” and “close” are recorded as the event is extracted as a history (step 1401) from the document table 1083, and then the process of step 1403 is performed.

The case where the document “A” was opened or closed several times in the past is considered. In this case, the number of combinations of the records of which the events are “open” and “close” for the document “A” extracted in step 1401 is plural. In this case, as for the time of “open” and the time of “close”, the records in which the time of “close” is closest to the time of “open” right before are combined and are used as the period in which the document “A” is utilized by the information processing device 10.

In step 1403, one non-processed search result record which is not processed in steps 1405 to 1415 is read from the document table 1083. A document indicated by the document address included in the record is referred to as document “B.”

Then, it is determined whether the time recorded in the record having a document address for identifying the document “B” and having one event of “create”, “open”, and “close” is included in the period in which the document “A” is utilized, that is, the period from the open time to the close time of the document “A” extracted in step 1401 (when the number of periods extracted is plural as described above, one of the periods) (step 1405).

When it is determined in step 1405 that the time of the record for the document “B” is included in the period obtained in step 1401 (step 1405: YES), the process of step 1409 is performed. When it is determined that the period is not included therein (step 1405: NO), the process of step 1407 is performed.

It is determined in step 1407 whether the period obtained in step 1401 is included in the period from the open time to the close time of the document “B.” When it is determined that the times of “open” and “close” of the document “A” are included in the period from the “open” time to the “close” time of the document “B” (step 1407: YES), the process of step 1409 is performed. On the other hand, when the times are not included therein (step 1407: NO), the process of step 1415 is performed.

In step 1407, when the “open” time of the document “B” in step 1405 is prior to the “open” time of the document “A” and the “close” time of the document “B” is posterior to the “close” time of the document “A”, it is possible to prevent the correlation from being non-processed in the document-outputting search process.

It is determined in step 1409 whether the document “B” is updated in the period from the open time to the close time of the document “B”, specifically, whether a record having a document address associated with the document “B”, a time included in the period, and an event “update” exists in the records read in step 1403. When this condition is satisfied (step 1409: YES), a correlation score p is given to the correlation of the document “B” with the document “A”, the record read from the document table 1083 in step 1403 is stored as the search result record (step 1413), and then the process of step 1415 is performed.

On the other hand, when it is determined in step 1409 that a record having the document address associated with the document “B”, the time included in the period, and the event “update” does not exist (step 1409: NO), the document “B” is correlated with the document “A” without performing the process of step 1411, the record read in step 1403 is stored as the search result record (step 1413), and then the process of step 1415 is performed.

The search result record when the process of step 1415 is performed directly after the process of step 1411 (step 1411: NO) is different from the search result record when the process of step 1413 is performed (step 1409: YES), in that the correlation score p given in step 1413 is stored or not. As for the other items, they are equal to each other.

It is determined in step 1415 whether a non-processed record remains in the document table 1083. When it is determined that anon-processed record remains (step 1415: NO), the process of step 1403 is performed again. When it is determined that all the records are processed (step 1415: YES), the document-outputting search process is ended and then the process of step 1323 is performed.

In this way, by performing the processes of step 1405 to 1413, the document data (document “A” and document “B”) stored in the storage unit 108 can be correlated with each other on the basis of the period in which the document data are utilized by an editor or the like installed in the PC 10 or the external device 20 to be managed by the PC 10 (generally referred to as “operating application”). In addition, when the document “B” correlated with the document “A” is updated in the period in which the document “B” is utilized, the correlation score can be given to the document “B” as being correlated with the document “A.”

When it is determined in step 1317 that the status ID of the read non-processed record does not indicate the document output (step 1317: NO), the process of step 1321 is performed.

In step 1321, in the records stored in the document table 1083 and set to the initial value of the search result record in step 1301, when a period from the time registered in the record having the event “create” or “open” to the time registered in the record having the event “close” and the same document address as the document address of the record having the event “create” (that is, a period when it can be determined that the same document is “opened” or “treated” by the PC 10) overlaps with the period from the start time to the end time of the record read from the status table 1081 in step 1315, the record to be processed in the document table 1083 is stored as the search result record (step 1321).

That is, in the process (step 1321), the status of the external device suitable for the instructed search condition and the documents which it is determined to be opened or utilized at the same period are extracted.

In the information management system 1 according to the first illustrative aspect, when it is intended to utilize again the data having been utilized at that time by using a user's behavior as a key, the document data having been utilized in the same period as the processing operation of the multifunction machine 20 or the like connected to the PC 10 can be considered as being correlated with the processing operation by using the processing operation as the information indirectly indicating the user's behavior. As a result, the document data having been utilized in the same period as the target document (address) as the target of the processing operation can be considered as being correlated with each other. Accordingly, the records having the event “create” or “open” of which the processing times overlap with each other are stored as the search result records.

In human behaviors, a user' behavior may be a “work having been performed a few days ago (for example, PC print work)”, in other words, maybe to utilize the document (target document) again used at that time by using the user's behavior as a key. In this case, in the information management system 1 according to the first illustrative aspect of the invention, since the document data having utilized in the same period as the processing operation can be considered as being correlated with each other as described above, it is possible to select and utilize a document having a high degree of correlation among a plurality of documents correlated with the target document by using another data having a high frequency of utilization and using the “work having been performed a few days ago” as a key.

When the period from the time registered in the record comprising the event “create” or “open” to the time registered in the record comprising the event “close” and comprising the same document address as the document address of the record comprising the event “create” is determined, the identity of the user (operator in FIG. 3) is considered.

In step 1323, it is determined whether the processes of step 1319 and step 1321 are performed to all the records stored as the search result records in the status table 1081. When it is determined that the process is performed to all the records (step 1323: YES), search result information is prepared from the search result record based on the above-mentioned process (step 1325), and then the document search process (step 1105) ends. When it is determined that the process is not performed to all the records (step 1323: NO), the processes repeat from step 1315.

In the information management system 1 according to the illustrative aspect, since the records stored in the status table 1081 are stored as records in the document table at the time of performing the processing operation (see “Document Table Updating Process” to be described later), the records in both tables satisfy the search conditions in step 1321 and are stored as the search result records.

Accordingly, since the search result records stored based on the records stored through the same process is excluded, the start time or the end time of the search result record specified from the status table 1081 is preferably equal to the time of the document table 1083. In addition, even when the condition of step 1321 is satisfied, the search result records in which the target document address and the document address are identical are preferably not stored in step 1321.

When the document search process (step 1105) is finished, the control section 100 performs a process of displaying the search result based on the document search process (step 1105) (step 1107).

In the document search process step 1321, the determination using the overlapping of two periods has been performed. However, when the time registered in the record comprising the event “create”, “open”, or “close” is comprised in the period from the start time to the end time of the records in the status table 1081, both periods necessarily overlap with each other. Accordingly, except for the case in which the period from the start time to the end time of the record in the status table 1081 is all comprised in the period from the time registered in the record comprising the event “create” or “open” to the time registered in the record comprising the event “close” and comprising the same document address as the document address of the record comprising the event “create” or the like, it is preferable in view of rapid determination to employ this simple determination along with the determination of step 1321.

Similarly, when one of the start time and the end time of the record of the status table 1081 is comprised in the period from the start time of the record comprising the event “create” or “open” to the time registered in the record comprising the event “close” and comprising the same document address as the document address of the record comprising the event “create” or the like, both periods necessarily overlap with each other. Accordingly, as described above, it is preferable in view of rapid determination to employ this simple determination along with the determination of step 1321.

When the time registered in the record comprising the event “create”, “open”, or “close” overlaps with one of the start time or the end time of the record in the status table 1081, both periods necessarily overlap with each other. Accordingly, as described above, it is preferable in view of rapid determination to employ this simple determination along with the determination of step 1321.

FIG. 15 is a diagram illustrating a flow of a search result display process (step 1107). First, at the time of starting the process, the date and the reference sort flag are set to OFF (step 1901).

Next, the search result records specified as the search result information prepared in step 1325 are classified into search result records specified from the status table 1081 (specified through steps 1303 to 1313), search result records specified from the document table 1083 (search result records specified by performing the process of step 1321), and search result records specified by performing the document-outputting search process (step 1319) to the document table 1083. That is, both search results are classified into a search result classified in step 1503 with the target document, a search result classified in step 1503 with the utilization document, and a search result classified in step 1503 with the utilization document (document output) (step 1503).

When the process of step 1503 is finished and then the search result information classified into the utilization documents and the target documents in step 1503 is displayed, a process of determining in what order the utilization documents and the target documents are displayed is performed.

First, it is determined in step 1505 whether a time sorting method is selected for the display order (step 1505).

The display of the search result associated with the target document and the search result associated with the utilization document, which are classified in step 1503, will be first described. When the reference-number sorting method is selected, that is, when the time sorting method is not selected (step 1505: NO), the search result records having been classified into the utilization documents and the target documents in step 1503 are sequentially sorted from the search result record having the largest reference number in the order of decreasing the reference number (step 1511), and then the time sort flag is set to ON (step 1513). Thereafter, the process of step 1515 is performed.

On the other hand, when the time sorting method is selected (step 1505: YES), the control section 100 sequentially sorts the search results obtained in step 1503 from the search result record having the latest time (step 1511), and then the time sort flag is set to ON (step 1513). Thereafter, the process of step 1515 is performed as described above.

The display of the search result associated with the utilization document (document output) which is classified in step 1503 will be described. When the time sorting method is not selected (step 1505: NO), the records are sequentially sorted in the order of decreasing the correlation score stored in step 1415 or the records having the same correlation score or the records having no correlation score are sorted in the order of decreasing the reference number, and the reference-number sort flag is set to ON (step 1509). Then, the process of step 1515 is performed.

On the other hand, when the time sorting method is selected (step 1505: YES), the control section 100 sequentially sorts the search result records in the order of the correlation scores set in step 1415, or sorts the records having the same correlation score or the records having no correlation score from the search result record having the latest time (step 1511), and then the time sort flag is set to ON (step 1513). Thereafter, the process of step 1515 is performed as described above.

In the information management system according to the first illustrative aspect, the search results can be sorted by the use of two items of the time and the reference number at the time of displaying the search results. Accordingly, it can be determined as follows by the use of which of the time and the reference number the search results are sorted. Only by determining whether the search results are sorted in one item, specifically, by determining whether the time sorting method is selected, it can be determined whether a user intends to sort the search results in which of the time and the reference number (when the time sorting method is not selected, it is considered that the reference number sorting method is selected).

When the search results are sorted in the order of the time or the reference number, which is used to sort the search results may be selected by the user through the operation section 104, for example, after performing the process of step 1901 and before performing the process of step 1905.

In step 1915, lists of the utilization documents, the target documents and the utilization document (document output) are prepared so as to access the documents on the basis of the search result records sorted in accordance with the condition selected in step 1907 or 1911. The lists are displayed in step 1917.

In the information management system 1 according to the first illustrative aspect, when the activation of the external device is detected in step 707, the during-activation intellectual assistance process (step 711) is performed in response to the detection. Accordingly, since the documents, which are considered as being opened or treated at the same time in the past can be notified to the user with the document data to be processed or the detecting operation. As a result, when a process is necessary for the documents associated with this process, the necessary process can be performed at the same time.

For example, in case of fax transmission, it is possible to determine whether the documents opened at the time of the previous fax transmission should be transmitted by opening the documents.

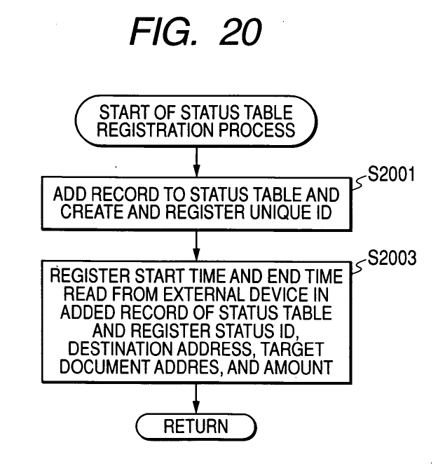

FIGS. 20 to 23 are diagrams illustrating the process results of the during-activation intellectual assistance process displayed on the display section 106 of the PC 10 by performing step 1917.

Specifically, FIG. 20 shows a search result associated with the target document specified by performing the during-activation intellectual assistance process (step 711) when an instruction of printing documents data stored in the storage section 108 is given to the recording section 202 of the multifunctional machine 20 from the PC 10 (a PC print operation is performed as the processing operation: see FIG. 3).

That is, when the PC print operation is performed, the document search process (step 1105) is performed on the basis of the target document address as a processing target of the PC print operation. As a result, the time when the target document data as a print target of the print operation were printed is displayed in the format shown in FIG. 20. In this case, the addresses and the reference numbers in FIG. 20 are displayed to be identical.

FIG. 17 shows a search result associated with the utilization document (document output) specified by performing the document-outputting search process (step 1319).

For example, when the PC print process is set to the ID in FIG. 2 “sid5” (the address of the target document (corresponding to the document “A” in the above description) in the record is “file://***/***/d1”), the ID “did5” in FIG. 4 is extracted as the time of the event “open” and the ID “did9” is extracted as the time of the event “close” in step 1401 of the document-outputting search process (step 1319). Then, the subsequent processes are performed. An address “file://***/***/d3” associated with the ID “did6” to the ID “did8” is correlated as the document “B” with the document “A” (step 1405: YES) and a correlation score is given to the correlation (step 1409: YES, step 1411). Then, it is stored as a search result record (step 1415).

Accordingly, as shown in FIG. 17, the address “file://***/***/d3” having the correlation score is displayed at the uppermost position (it is assumed that the correlation score is not given to the other documents).

In the above-mentioned example, all the records associated with the ID “did6” to the ID “did8” are stored as the search result records, but since they are a record of the same document, the records are displayed uniquely as “file://***/***/d3” as shown in FIG. 17.

FIGS. 18 (display based on the search result associated with the target document) and 19 (display based on the search result associated with the utilization document) show display examples when the communication results from the emission of a telephone call (event “TLT” in FIG. 3) or the reception of a telephone call (event “TLR” in FIG. 3) through the line communication unit 212 of the multifunction machine 20 in step 707) and it is determined in step 1317 that the status ID does not indicate the document output (step 1317: NO) (the course to the display is the same as described with reference to FIG. 14 and thus is omitted).

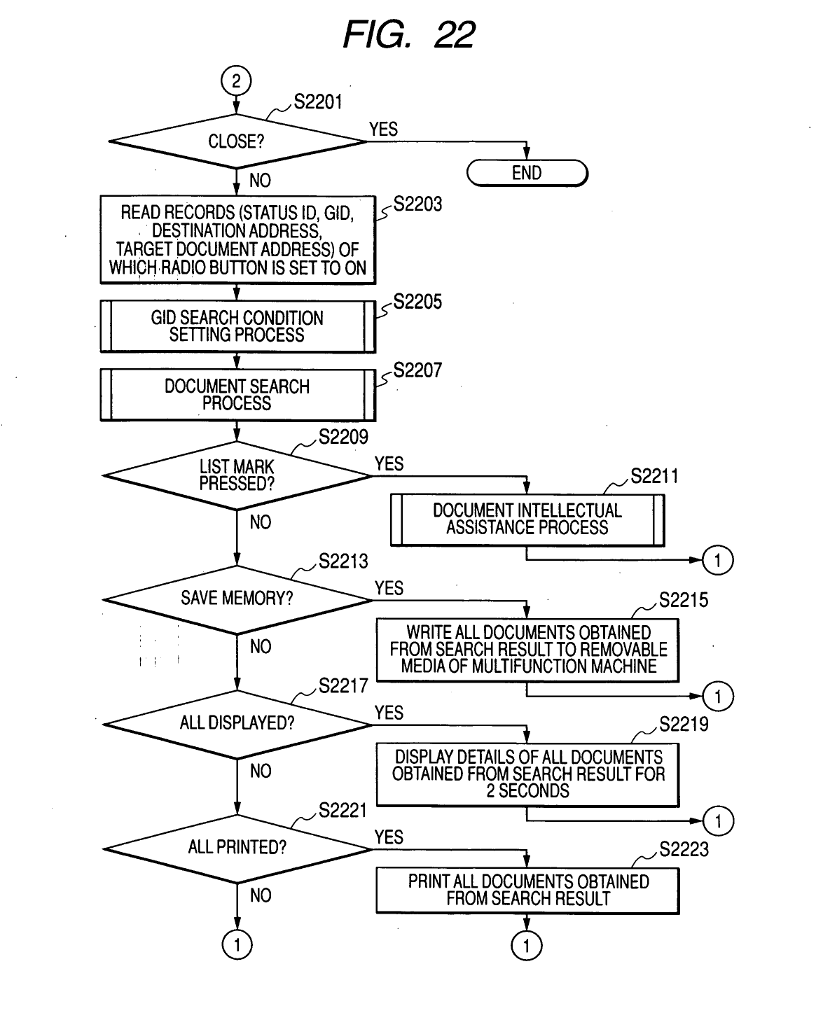

In FIG. 20, since the processing operation is a PC print operation, the GID is “1” (see FIG. 3), and the document search process (step 1105) is performed using the document address as the search condition, the addresses and the reference numbers are identical and only the times are different from each other. However, in case of the telephone transmission or the telephone reception, the GID is “2” (see FIG. 3) and the document search process (step 1105) is performed without using the document address as the search condition. Accordingly, the target document addresses shown in “Address” of FIG. 22 are different from each other.

In the information management system 1 according to the first illustrative aspect, the addresses in FIGS. 20 to 23 are displayed in the hyperlink format (step 1917), and when the hyperlinks are selected using the operation section 104, the document data associated with the address are read from the storage section 108 and are displayed on the display section 106.

(Status Table Registering Process)

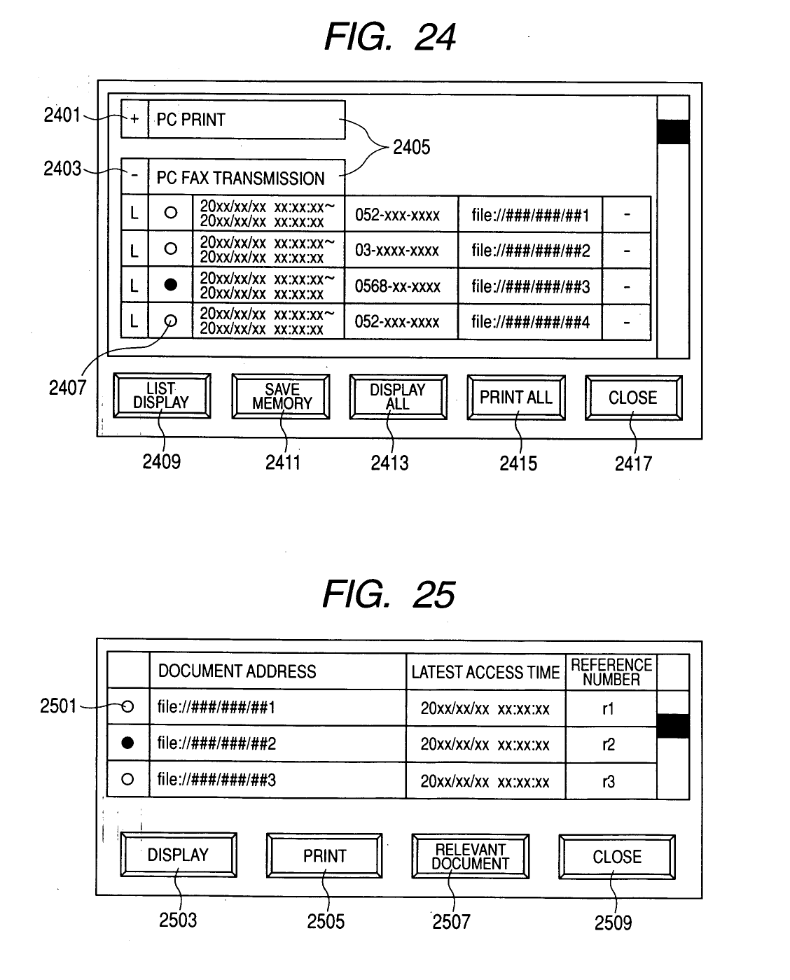

FIG. 24 is a diagram illustrating a flow of a registering process in the status table 1081 shown in FIG. 2A.

When the status table registering process is performed in step 715, the control section 100 of the PC 10 additionally creates a unique ID of a record to be registered in the status table 1081. Then, the control section registers the unique ID as an ID of the new record (step 2401) and then performs the process of step 2403.

In step 2403, the time when the activation of the external device is detected in step 707 and the time when the activation end of the external device of which the activation has been detected in step 707 is detected in step 713 are registered as the start time and the end time of the new record in step 2401, respectively, and the status ID, the destination address, the target document address, and the amount, which are input from the external device of which the activation has been detected and stored in the RAM or the like of the control section 100 in step 709 before the during-activation intellectual assistance process (step 711), are similarly registered in the new record in step 2401.

(Manual Intellectual Assistance Process)

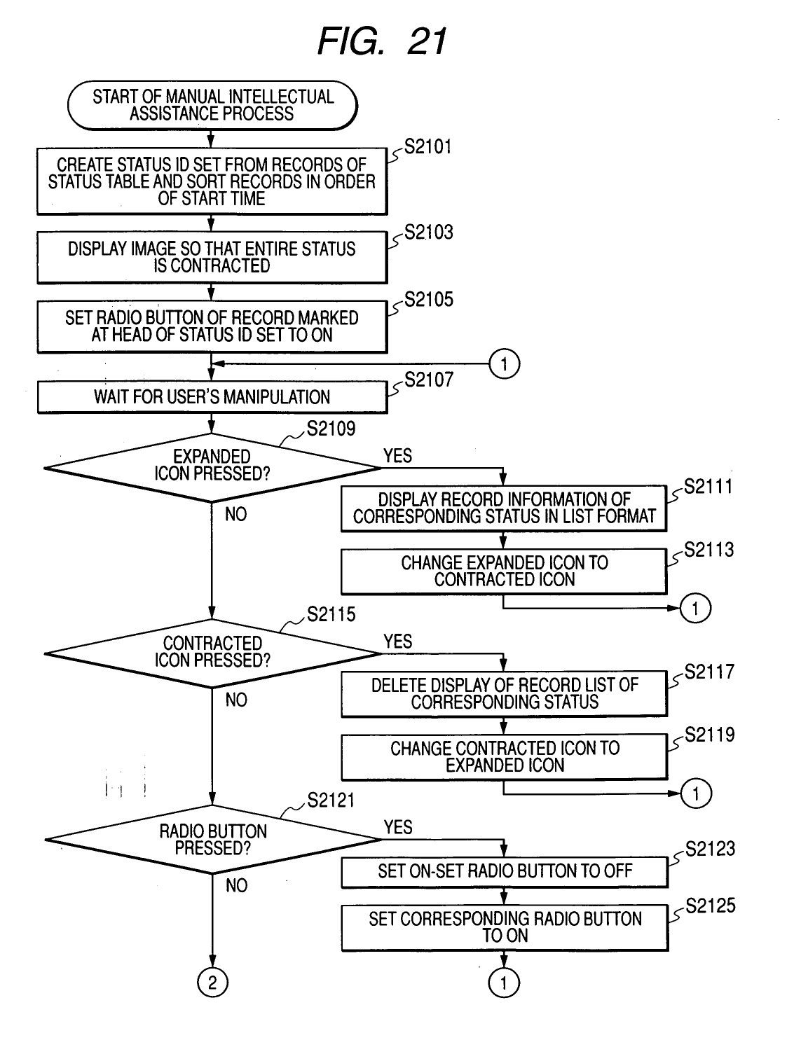

FIGS. 21 and 22 are diagrams illustrating a flow of the manual intellectual assistance process. FIG. 24 is a diagram illustrating a display format of information displayed on the display section 106 of the PC with the performing of the manual intellectual assistance process.

In step 719, with the start of the manual intellectual assistance process, this process starts. This process operates in parallel to the PC main process shown in FIG. 7. That is, the process of step 719 proceeds to the process of step 701 without waiting for the end of the manual intellectual assistance process after the manual intellectual assistance process starts.

The control section 100 of the PC 10 creates a set of status IDs from the records of the status table 1081, performs a process of sorting the records of the set of status IDs in the order of start times (step 2101), and displays the result of the process on the display section 106 of the PC 10 (step 2503).

Here, in step 2103, the entire statuses are displayed in a contracted format, and specifically, only the titles of the processing operations indicated by the status IDs are displayed (see the display format of the PC print operation in FIG. 24).

In step 2105, in the display format displayed through the process of step 2103, a radio button 2407 (see FIG. 24) of the head record (the record sorted in the head in step 2101) of the status 2405 displayed at the uppermost position (PC print in FIG. 24) is set to ON with the initial setting (step 2405).

In the state in which the processes up to step 2105 are performed after the manual intellectual assistance process starts (step 719), the control section 100 waits until a user manipulates by the use of the operation section 104 (step 2107).

In the wait state (step 2107), when the user input an instruction by the use of the operation section 104, the control section 100 determines whether the instruction is to press an expanded icon 2401 (see FIG. 24) (step 2109).

Here, when the input instruction is to press the expanded icon 2401 (step 2109: YES), the record information of the status 2405 corresponding to the pressed expanded icon 2401 is displayed in a list format in response to the sorting process of step 2101 (step 2111) and the expanded icon 2401 of the expanded status 2405 is changed to a contracted icon 2403 (step 2113).

The processes of steps 2111 and 2113 are specifically described with reference to FIG. 24. In case of the PC fax transmission operation, the status 2405 is displayed along with the expanded icon 2401, similarly to the PC print operation, before the expanded icon 2401 is pressed (step 2109) (in other words, the list (records) is not displayed).

In this state, when the process of step 2109 is performed to the expanded icon 2401 for the PC fax transmission (step 2109: YES), the records of which the status IDs are marked “FPT” in the status table 1081 are displayed in the format shown in FIG. 24 in the sorting order of step 2101 (step 2111), and the expanded icon 2401 associated with the PC fax transmission is changed to the contracted icon 2403 (step 2113: the display is changed from “+” to “−”). At the time of first ending the process of step 2113, the process of step 2105 is valid, and all the radio buttons 2407 are set to OFF in the records displayed associated with the PC fax transmission.

On the other hand, in the wait state of step 2107, when the input instruction is not to press the expanded icon 2401 (step 2109: NO), but to press the contracted icon 2403 (step 2115: YES), the display in the PC fax transmission format shown in FIG. 24 is changed to the PC print format. That is, the display of the record list of the corresponding status 2405 is erased (step 2117) and the contracted icon 2403 is changed to the expanded icon 2401 (step 2119).

In the wait state of step 2107, when the input instruction is not to press the contracted icon 2403 (step 2115: NO), but to press the radio button 2407 (step 2121: YES), the radio button 2407 set to ON for a predetermined record (the head record of the uppermost status 2405 in the initial state) is changed to OFF (step 2123) and the radio button 2407 corresponding to the user's manipulation is set to ON (step 2125).

After the processes of step 2113, 2119, and 2125 are performed, the control section waits in step 2107 until the user's manipulation is performed.

Here, in the wait state of step 2107, when the instruction input by the user's manipulation is not to press any one of the expanded icon 2401, the contracted icon 2403, and the radio button 2407 (steps 2109, 2115, and 2121: NO), the process shown in FIG. 22 is performed.

That is, the control section 100 of the PC 10 determines whether the instruction input by the user's manipulation is the end of the manual intellectual assistance process, specifically, whether a closing button 2417 is pressed (step 2201). When it is YES (step 2201: YES), the process ends.

On the contrary, when the instruction is not to press the closing button 2417 (step 2201: NO), the instruction is to press a list display button 2409, a memory storage button 2411, an all display button 2413, or an all print button 2415. Accordingly, in order to perform the processes corresponding to the buttons, the records of which the radio button is set to ON (status ID, GID, destination address, target document) are read (step 2203).

The GID search condition setting process (step 2205) and the document search process (step 2207) are performed on the basis of the read information, and then the process of step 2209 is performed. Both processes performed in steps 2205 and 2207 are similar to the GID search condition setting process (step 1103) and the document search process (step 1105) performed in the during-activation intellectual assistance process (step 711), and thus description thereof is omitted.

In step 2209, it is determined whether the instruction, which is input through the user's manipulation of the operation section 104 and which results in the performing of the process of step 2203 is to press the list display button 2409.

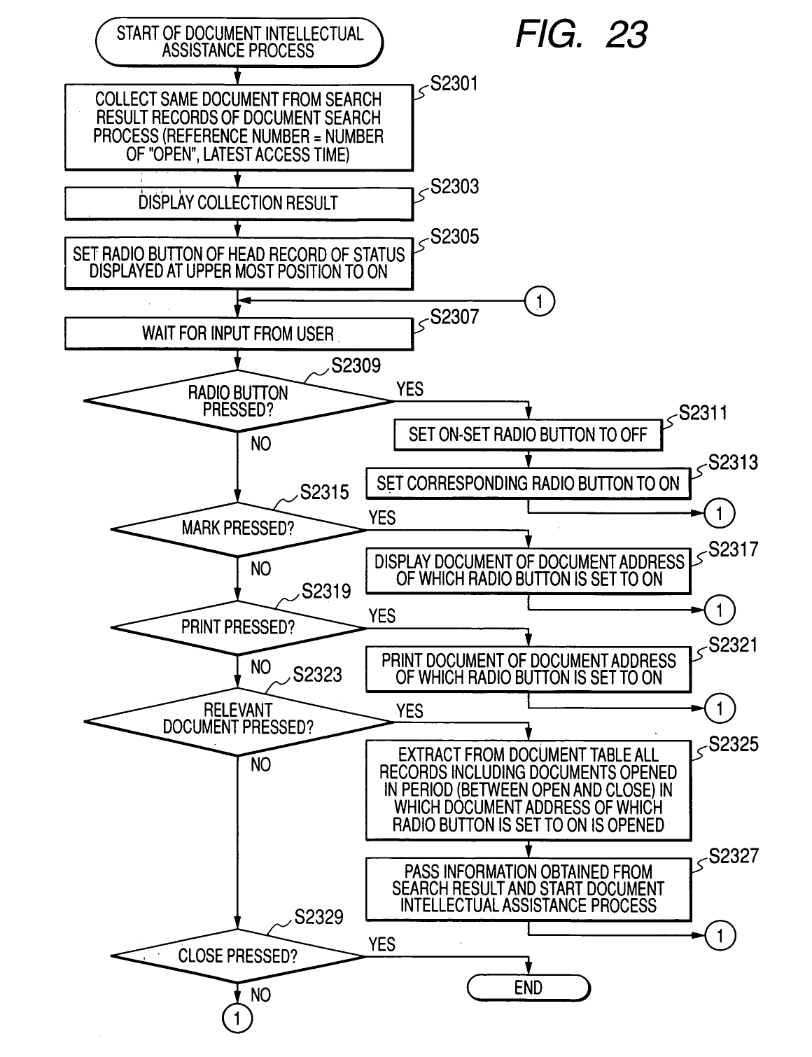

When the instruction is to press the list display button 2409 (step 2209: YES), the document intellectual assistance process is activated by the use of the result of the document search process of step 2207 (step 2211). The details of the document intellectual assistance process are described later with reference to FIG. 23.

On the contrary, when the instruction is not to press the list display button 2409 (step 2209: NO), it is determined whether the instruction is to press the memory storage button 2411 (step 2213). When it is YES (step 2213: YES), the control section 100 instructs the multifunction machine 20 to write the document data of the document address described in the search result record obtained through the document search process (step 2207) to a removable media 2101, and transmits the corresponding document data from the storage section 108 to the multifunction machine 20 through the communication section 102. On the other hand, the control section 200 of the multifunction machine 20 writes the corresponding document data received through the communication section 214 in response to the instruction to the removable media 2101 (step 2215).

When the instruction is not to press the memory storage button 2411 (step 2213: NO), it is determined whether the instruction is to press the all display button 2413 (step 2217). When it is YES (step 2317: YES), the control section 100 opens the document data of the document address described in the search result record obtained through the document search process (step 2207), and sequentially displays the contents on the display section 106 with a predetermined interval of time, for example, 2 seconds (step 2219).

When the instruction is not to press the all display button 2413 (step 2217: NO), it is determined whether the instruction is to press the all print button 2415 (step 2217). When it is YES (step 2217: YES), the control section 100 transits the document data of the document address described in the search result record obtained through the document search process (step 2207) to the multifunction machine 20 through the communication section 102, and allows the recording section 202 of the multifunction machine 20 to print the document data (step 2223).

When the instruction is not to press the all print button 2415 (step 2221: NO), a process corresponding to the press is performed or it is determined that the press is erroneous. Then, the control section waits until the user's manipulation is performed (step 2107).

When the processes of steps 2211, 2215, 2219, and 2223 are finished, the control section waits in step 2107 until the user's input is performed.

FIG. 23 is a diagram illustrating a flow of the document intellectual assistance process started in step 2211. FIG. 25 is a diagram illustrating a display format of information displayed on the display section 106 of the PC 10 at the time of performing the document intellectual assistance process.

First, in step 2301, the control section 100 of the PC 10 collects the number of reference to the document data (the number of records of which the event is “open”) of the same document address and the final access time (time described in the latest record) from the search result records obtained through the document search process (step 2207) by the use of the records comprising the same document address (step 2301), and then performs the process of step 2303.

In step 2303, the collection result is displayed in the format shown in FIG. 25 on the display unit 106. At this time, the radio button of the head record among the displayed records is set to ON (step 2305). In step 2303, the display process maybe performed by performing the same processes as steps 1505 to 1513 of the search result display process (step 1107). However, in the first illustrative aspect, the display process is performed on the basis of only the collection of step 2301. More specifically speaking, since the search result associated with the utilization document and the search result associated with the utilization document (document output) are collected without distinguishment in step 2301, the collection result is not displayed in consideration of the correlation score, unlike the search result display process (step 1107).

Here, in the state in which the processes up to step 2305 are performed after the document intellectual assistance process starts (step 2211), the control section 100 waits until the user manipulates the operation section 104 (step 2307).

In the wait state (step 2307), when the user input an instruction through the operation section 104, the control section 100 determines whether the input instruction is to press the radio button 2501 (see FIG. 25) (step 2309). When it is YES (step 2309: YES), the process of step 2301 is performed.

In step 2307, the radio button 2501 set to ON in a predetermined record (the head record in the initial state) is set to OFF (step 2311) and the radio button 2501 corresponding to the user's manipulation is set to ON (step 2313).

On the other hand, when it is determined in step 2309 that the input instruction is not to press the radio button 2501, it is determined whether the input instruction is to press the display button 2403 (step 2315). When it is YES (step 2315: YES), the process of step 2317 is performed.

In step 2317, the document data of the document address in which the radio button is set to ON is opened and displayed on the display section 106.

When it is determined in step 2315 that the input instruction is not to press the display button 2503, it is determined whether the input instruction is to press the print button 2505 (step 2319). When it is YES (step 2319: YES), the process of step 2321 is performed.

In step 2321, the control section 100 reads the document data of the document address, in which the radio button is set to ON, from the storage section 108 and transmits the document data to the multifunction machine 20 through the communication section 102, and the recording section 202 of the multifunction machine 20 prints the document data.

When it is determined in step 2319 that the input instruction is not to press the print button 2505, it is determined whether the input instruction is to press a relevant document button 2407 (step 2323). When it is YES (step 2323: YES), the process of step 2325 is performed.

In step 2325, all the records of which the event is “open” in the period (between open and close) when the document data of the document address in which the radio button 2501 is set to ON are opened are extracted from the document table 1081 (step 2325).

Specifically describing the process with reference to FIG. 25, since the document data stored at the document address “file:/###/###/###2” comprises the number of reference of r2, the document data are opened r2 times. Accordingly, the extraction is performed to all the r2 periods.

When the period when the document data of the document address in which the radio button 2501 is set to ON is determined, the identity of the user (operator in FIG. 4) is considered.

The document intellectual assistance process starts again with respect to the search result records obtained through the extraction process of step 2325 (step 2327).

That is, the user can sequentially see documents associated with a document by performing the document intellectual assistance process.

When it is determined in step 2323 that the input instruction is not to press the relevant document button 2507, the control section 100 determines whether the input instruction is to press the closing button 2509 (step 2329). When it is YES (step 2329: YES), the control section ends the document intellectual assistance process (step 2211) and waits in step 2107 until the user's manipulation is performed.

On the other hand, when it is determined that the input instruction is not to press the closing button 2509 (step 2329: NO), the control section performs a process corresponding to the press or determines that the press is erroneous, and waits until the user's manipulation is performed (step 2307).

After performing the processes of steps 2313, 2317, 2321, and 2327, the control section waits again in step 2307 until the user's input is performed.

(Process 2 of Information Management System)

Next, a process (2) of the information management system 1 comprising the above-mentioned configuration is described with reference to the drawings. The process (2) starts in parallel to the process (1).

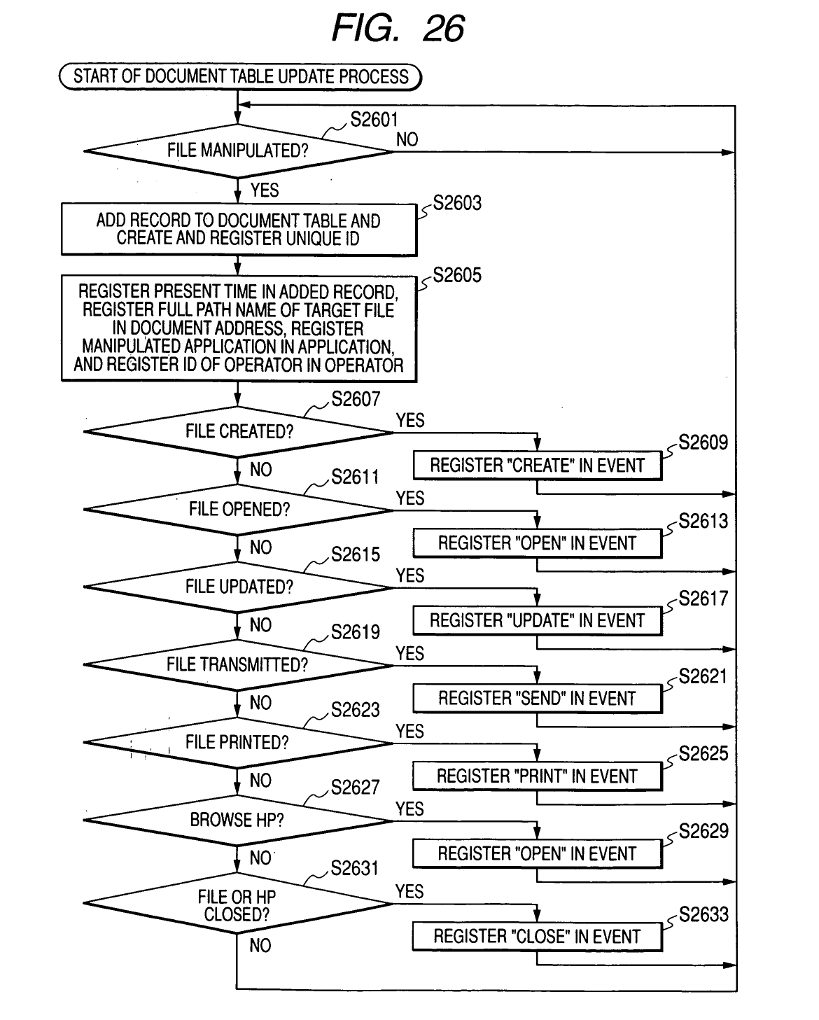

FIG. 26 is a diagram illustrating a flow of a process of updating the document table 1083 performed by the PC 10. The process (2) shown in the flow is performed by the control section 100 of the PC 10, and more specifically, is performed by the CPU of the control section 10 by the use of the program stored in the ROM or the like.

First, when the document data stored in the storage section 108 are manipulated by the use of the operation section 104 or the operation of the multifunction 20 is carried out, that is, when the target document data are transmitted to the PC 10 from the multifunction machine 20 by starting the processing operation (status) described as “(copied to PC)” among the items of the “target document address” of FIG. 3, the target document data are newly stored in the storage section 108, the RFID tags 322 and 324 of the books 32 and 34 are read by the RFID tag reading section 306 of the book sensor 30, and the information is transmitted to the PC 10 through the communication section 34, the control section 100 determines whether a homepage (hereinafter, referred to as “HP”) on Internet 70, which introduces the book 32 or the like associated with the transmission from the book sensor 30, is opened (hereinafter, the manipulations or processes are referred to as “file manipulation”) (step 2601).

When it is determined in step 2601 that the file manipulation is performed (step 2601: YES), the control section 100 adds a record to the document table 1083, creates an ID unique to the record, registers the unique ID (step 2603), and then performs the process of step 2605.

When it is determined in step 2601 that the condition is not satisfied (step 2601: NO), the control section waits until the file manipulation is performed.

In step 2605, the present time is registered to the record added in step 2603, registers an application obtained by preparing a full pass name of the target file with a application to the document address, and registers the type of the operator to the operator.

Thereafter, a process of determining information to be registered to the “event” not yet registered is performed (steps 2607 to 2633).

First, the control section 100 determines whether the file manipulation performed in step 2601 is to store a new document file in the storage section 108 (hereinafter, referred to as “file creation” (step 2607). The control section registers “create” as an event, when the file manipulation is the file creation (step 2607: YES).

On the other hand, when the file manipulation is not the file creation (step 2607: NO), the control section determines whether the file manipulation is to open the document file stored in the storage section 108 (hereinafter, referred to as “file opening”) (step 2611). When it is YES (step 2611: YES), the control section registers “open” as an event (step 2613).

When it is not YES in step 2611 (step 2611: NO), it is determined whether the document data stored in the storage section 108 is updated (overwritten) (step 2615). When it is YES (step 2615: YES), “update” is registered as an event (step 2113).

When it is not YES in step 2615 (step 2615: NO), it is determined whether the document data stored in the storage section 108 is transmitted (the PC fax transmission is comprised) (step 2619). When it is YES (step 2619: YES), “send” is registered as an event (step 2621).

When it is not YES in step 2619 (step 2619: NO), it is determined whether the document data stored in the storage section 108 is printed (which corresponds to the status “PC fax transmission” in FIG. 3) (step 2619). When it is YES (step 2619: YES), “send” is registered as an event (step 2621).

When it is not YES in step 2615 (step 2615: NO), it is determined whether the document data stored in the storage section 108 is printed (the recording section 202 of the multifunction machine 20 is used) (step 2623). When it is YES (step 2623: YES), “print” is registered as an event (step 2625).

When it is not YES in step 2623 (step 2623: NO), it is determined whether the HP is opened (step 2627). When it is YES (step 2627: YES), “open” is registered as an event (step 2629).

When it is not YES in step 2627 (step 2627: NO), it is determined whether the file or HP is closed, which corresponds to the file opening (step 2611) or the HP opening (step 2627) (step 2631). When it is YES (step 2631: YES), “close” is registered as an event (step 2629).

When it is not YES in step 2631 (step 2631: NO), the control section 100 waits until a file manipulation is performed again, after finishing the process of step 2609, 2613, 2617, 2621, 2625, 2629, or 2633.

Hitherto, the “document data” have been mainly exemplified in the description according to the first illustrative aspect. However, the data as a target of the information management system 1 are not limited to the “document data”, but the same details (processes) may be performed to, for example, “image data”, “sound data”, other data, or mixtures of the data.

### SECOND EXAMPLE

Hereinafter, an information management system different from the first illustrative aspect will be described specifically.

A second illustrative aspect of the invention is different from the first illustrative aspect, in that the “GID” used in the first illustrative aspect is not provided, that is, the “GID” is not defined in FIG. 3 and the “GID search condition setting process” is not performed in the during-activation intellectual assistance process and the manual intellectual assistance process. Therefore, the details of the same configuration and process order are omitted but only differences are described in the following description (since the process order in the manual intellectual assistance process is similar to the during-activation intellectual assistance process, the during-activation intellectual assistance process is substantially described in the second illustrative aspect).

(During-Activation Intellectual Assistance Process)

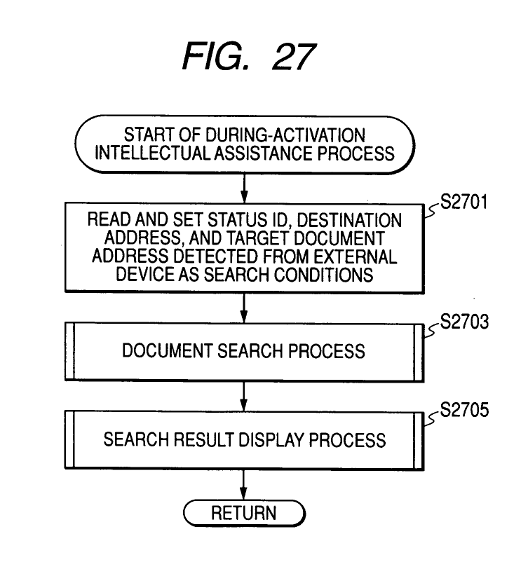

FIG. 27 is a diagram illustrating a flow of the during-activation intellectual assistance process.

When the during-activation intellectual assistance process is performed in step 711 of FIG. 7, the control section 100 of the PC 10 first reads the status ID, the destination address, and the target document address input (detected) by the external device from the RAM in step 709. The control section sets the data selected by the user through the operation section 104 as a search condition (step 2701), and performs the document search process (step 2703).

FIG. 13 is a diagram illustrating a flow of the document search process (step 2703). First, all the records in the status table 1081 and the document table 1083 are set to the initial values of the search result records (step 1301).

Next, in order to specify the target document associated with a specific record from the status table 1081, a search process is performed on the basis of the search condition selected in step 2703.

That is, in step 1303, it is determined whether the status ID is set as the search condition (step 1303). When it is YES (step 1303: YES), the record corresponding to the status ID set as the search condition in the status table 1081 is stored as the search result record (step 1305) and the process of step 1307 is performed. When the status ID is not set as the search condition (step 1303: NO), the process of step 1307 is performed without performing the process of step 1305.

In step 1307, it is determined whether the destination address is added as the search condition. When it is YES (step 1307: YES), the record corresponding to the destination address designated as the search condition among the search result records stored in step 1305 is stored as the search result record (step 1309) and then the process of step 1311 is performed. In step 1307, when the destination address is not added as the search condition (step 1307: NO), the process of step 1311 is performed without performing the process of step 1309.

In step 1311, it is determined whether the target document address is added as the search condition. When it is determined that the target document address is set (step 1311: YES), the record corresponding to the target document address designated as the search condition among the search result records stored in step 1305 and the like is stored as the search result record (step 1313) and then the process of step 1315 is performed. When it is determined in step 1311 that the target document address is not added as the search condition (step 1311: NO), the process of step 1315 is performed without performing the process of step 1313.

Here, the search result records obtained through the processes of steps 1303 to 1313 will be described in more detail.

When it is YES in steps 1303, 1307, and 1311, the final search result records comprise the records in the same status table 1081 as being stored in step 1313.

When it is YES in steps 1303 and 1307 and it is NO in step 1311, the final search result records comprise the records in the same status table 1081 as being stored in step 1309.

When it is YES in steps 1303 and 1311 and it is NO in step 1307, the final search result records comprise the records in the same status table 1081 as being stored in step 1313.

When it is YES in step 1303 and it is NO in steps 1307 and 1311, the final search result records comprise the records in the same status table 1081 as being stored in step 1305.

When it is NO in step 1303 and it is YES in steps 1307 and 1311, the final search result records comprise the records in the same status table 1081 as being stored in step 1313.

When it is NO in steps 1303 and 1311 and it is YES in step 1307, the final search result records comprise the records in the same status table 1081 as being stored in step 1309.

When it is NO in steps 1303 and 1307 and it is YES in step 1311, the final search result records comprise the records in the same status table 1081 as being stored in step 1313.

When it is NO in steps 1303, 1307 and 1311, the final search result records comprise the records in the same status table 1081 as the status table 1081 set as an initial value in step 1301.

In step 1315, in order to perform the processes subsequent to step 1317, a non-processed search result record is read from the search result records specified in steps 1303 to 1313 and then the process of step 1317 is performed.

The processes after step 1317 are similar to those of the first illustrative aspect including the search result display process 2605, and thus details thereof are not described.

What is claimed is:

1. An information management device comprising:
a data storage unit that stores a plurality of data;
a utilization unit that utilizes the data;
a period specifying unit that specifies a period in which the data is utilized by the utilization unit;
a utilization information specifying unit that specifies identification information to identify the data which is used by the utilization unit in the period specified by the period specifying unit and event information indicating a utilization form of the utilization unit;
a utilization information storage unit that correlates and stores the period, the identification information, and the event information which are specified by the period specifying unit and the utilization information specifying unit;
a correlation giving unit that correlates first data and second data with each other when a first period for the first data and a second period for the second data stored in the utilization information storage unit overlaps with each other;
a relevant information output unit that outputs second identification information to identify the second data correlated with the first data by the correlation giving unit;
an event information specifying unit that specifies the event information stored in the utilization information storage unit for the second data correlated by the correlation giving unit;
a score giving unit that gives a score to the correlation of the first data with the second data when the event information specified by the event information specifying unit indicates one utilization form and the utilization in the utilization form is performed in the second period; and
a relevant information output control unit that controls to output the second identification information, to which the score is given by the score giving unit, on the basis of the given score.

2. An information management system comprising:
an information management device comprising:
a data storage unit that stores a plurality of data;
a utilization unit that utilizes the data;
a period specifying unit that specifies a period in which the data is utilized by the utilization unit;
a utilization information specifying unit that specifies identification information to identify the data which is used by the utilization unit in the period specified by the period specifying unit and event information indicating a utilization form of the utilization unit;
a utilization information storage unit that correlates and stores the period, the identification information, and the event information which are specified by the period specifying unit and the utilization information specifying unit;
a correlation giving unit that correlates first data and second data with each other when a first period for the first data and a second period for the second data stored in the utilization information storage unit overlaps with each other;
a relevant information output unit that outputs second identification information to identify the second data correlated with the first data by the correlation giving unit;
an event information specifying unit that specifies the event information stored in the utilization information storage unit for the second data correlated by the correlation giving unit;
a score giving unit that gives a score to the correlation of the first data with the second data when the event information specified by the event information specifying unit indicates one utilization form and the utilization in the utilization form is performed in the second period; and
a relevant information output control unit that controls to output the second identification information, to which the score is given by the score giving unit, on the basis of the given score; and
an external device which is connected to the information management device in a communication-practicable manner and has at least one function performing unit including an output unit that outputs data in response to a command from the information management device,
wherein the external device comprises a transmission unit that transmits process specifying information, which is used to specify a process on condition that the process is performed by the function performing unit, to the information management device,
wherein the information management device comprises:
a reception unit that receives the process specifying information transmitted from the external device;
a process information storage unit that correlates and stores the process specifying information received by the reception unit with third identification information to identify the data as a target of the process; and
a process detail determining unit to determine that the process specifying information stored in the process information storage unit is associated with the output unit,
wherein the utilization units instruct the external device to output the data, and
wherein the correlation giving unit correlates data associated with the third identification information correlated and stored with the process specifying information as a target of the determination and a period correlated with the data associated with the third identification with each other as the first data and the first period, when the process detail determining unit determines that the process specifying information is associated with the output unit.

3. A computer usable medium having computer readable instructions stored thereon, the instructions enabling a computer to perform predetermined operations including the steps of:
storing a plurality of data;
utilizing the data;
period specifying for specifying a period in which the data are utilized;
utilization information specifying for specifying identification information to identify the data which is used by the utilizing in the period specified by the period specifying and event information indicating a utilization form of the utilizing;
utilization information storing for correlating and storing the period, the identification information, and the event information which are specified by the period specifying and the utilization information specifying;
correlation giving for correlating first data and second data with each other when a first period for the first data and a second period for the second data stored in the utilization information storing overlaps with each other;
a relevant information outputting for outputting second identification information to identify the second data correlated with the first data by the correlation giving;
event information specifying for specifying the event information stored in the utilization information storing for the second data correlated by the correlation giving;
score giving for giving a score to the correlation of the first data with the second data when the event information specified by the event information specifying indicates one utilization form and the utilization in the utilization form is performed in the second period; and
relevant information output controlling for controlling to output the second identification information, to which the score is given by the score giving, on the basis of the given score.
